(19) United States
(12) Patent Application Publication
(10) Pub. No.: US 2002/0177088 A1
(43) Pub. Date: Nov. 28, 2002

(54) Heat-developable silver halide color photographic light-sensitive material and image-forming method using the same

(76) Inventor: Jun Arakawa, Minami-ashigara-shi (JP)

Correspondence Address: BIRCH STEWART KOLASCH & BIRCH, PO BOX 747, FALLS CHURCH, VA, 22040-0747, US

(21) Appl. No.: 10/067,787

(22) Filed: Feb. 8, 2002

(30) Foreign Application Priority Data
Feb. 13, 2001 (JP) 2001-35441

(51) Int. Cl. G03C 1/42; G03C 1/498; G03C 1/91; G03C 1/795

(52) U.S. Cl. 430/523; 430/620; 430/627; 430/350

(57) ABSTRACT

A heat-developable silver halide color photographic light-sensitive material, which has a support and contains, on the support, a photosensitive silver halide, an organosilver salt, a developing agent, and a coupler that is capable of forming a dye upon a coupling reaction with an oxidized developing agent,

wherein the light-sensitive material satisfies the following condition:

(A) that the support is a plastic film whose glass transition temperature is from 120° C. to 350° C.; and/or

(B) that the light-sensitive material contains a hydrophilic binder on the support, and a non-light-sensitive layer containing a hydrophilic binder is provided on the side opposite to a light-sensitive layer side, with the support being between the layers, and the light-sensitive layer contains the photosensitive silver halide.

### FIELD OF THE INVENTION

The present invention provides a silver halide photographic light-sensitive material, and a color image-forming method for obtaining a high-quality color image in a rapid way. More specifically, the present invention relates to improvement of the quality of an image read out when a color photographic light-sensitive material for heat development is subjected to high-temperature, short-time processing to form an image, and the resulting image is read by a scanner.

### BACKGROUND OF THE INVENTION

Heretofore, processes for forming an image by heat development are described in, for example, U.S. Pat. Nos. 3,152,904 and 3,457,075, by D. Klosterboer in “Thermally Processed Silver Systems” (Imaging Processes and Materials, Neblette, 8th edition, edited by J. Sturge, V. Walworth, and A. Shepp, Chapter 9, page 279, 1989). These heat-developable light-sensitive materials contain a reducible non-photosensitive silver source (e.g., an organosilver salt), a catalytically active amount of a photocatalyst (e.g., a silver halide), and a reducing agent for silver, which are ordinarily in a state of dispersion in an organic binder matrix. The light-sensitive materials are stable at normal temperature, but when heated to a high temperature (e.g., 80° C. or above) after exposure, silver is formed through an oxidation-reduction reaction between the reducible silver source (acting as an oxidizing agent) and the reducing agent. This oxidation-reduction reaction is accelerated by a catalytic action of the latent image formed by the exposure. Since the silver produced by the reaction of the reducible silver salt in the exposed area becomes black in contrast with the non-exposed area, thereby to form an image.

On the other hand, as to the color image-forming method for a photographic light-sensitive material, a method utilizing a coupling reaction between a coupler and an oxidized developing agent, is most common. Heat-developable color light-sensitive materials employing this method are described, for example, in U.S. Pat. Nos. 3,761,270 and 4,021,240, JP-A-59-231539 (“JP-A” means unexamined published Japanese patent application), and JP-A-60-128438. Since the coupler has no absorption in the visible light region before being processed, the light-sensitive material according to the coupling system is more advantageous in terms of sensitivity than a light-sensitive material using the above-mentioned colorant, and the said material can be advantageously used not only as a print material but also as a photographic material for shooting.

A color photographic material for shooting, which uses the coupling reaction, is disclosed in JP-A-10-260518. According to this method, a light-sensitive material and a processing material coated with a base precursor, are put together in the presence of a small amount of water, and these materials are heated. However, from the viewpoint of downsizing and simplification of the processing apparatus, there has been strong demand for a system that does not use either the small amount of water or the processing material.

As an example of a heat-developable color photographic material for shooting that does not use a small amount of water and the processing material, JP-A-2000-171961 describes a light-sensitive material and a development method using the light-sensitive material. Pursuant to this method, a light-sensitive layer, which comprised gelatin, an organosilver salt, a silver halide, a developing agent, and the like, was coated on a PET base (support), and heat development was conducted at 140° C. for 10 seconds. As a result, the light-sensitive material caused a curling phenomenon, with the light-sensitive layer side made to face the inside, and a serious problem was found in the subsequent readout operation by a scanner. Further, even if the light-sensitive material was subjected to scanning by carefully holding the film periphery, planarity (flatness) within the image plane was poor, and it was found that the sharpness of the color image outputted after being read out by a scanner was very poor.

### SUMMARY OF THE INVENTION

The present invention is a heat-developable silver halide color photographic light-sensitive material, which has a support, and which contains, on the support, a photosensitive silver halide, an organosilver salt, a developing agent, and a coupler that is capable of forming a dye upon a coupling reaction with an oxidized product of the developing agent,

wherein the light-sensitive material satisfies the following condition:

(A) that the support is a plastic film whose glass transition temperature (Tg) is 120° C. or higher, but 350° C. or lower; and/or

(B) that the light-sensitive material contains a hydrophilic binder on the support, and a non-light-sensitive layer containing a hydrophilic binder is provided on the side opposite to a light-sensitive layer side, with the support being between the layers, and the light-sensitive layer contains the photosensitive silver halide.

Further, the present invention is a color image-forming method, which comprises: heating the silver halide photographic light-sensitive material at a temperature of 130 to 200° C. for 3 to 30 seconds, thereby forming an image.

Other and further features and advantages of the invention will appear more fully from the following description.

### DETAILED DESCRIPTION OF THE INVENTION

According to the present invention, there is provided the following means:

(1) A heat-developable silver halide color photographic light-sensitive material, which has a support, and which contains, on the support, a photosensitive silver halide, an organosilver salt, a developing agent, and a coupler that is capable of forming a dye upon a coupling reaction with an oxidized product of the developing agent,

wherein the light-sensitive material satisfies the following condition:

(A) that the support is a plastic film whose glass transition temperature is 120° C. or higher, but 350° C. or lower; and/or

(B) that the light-sensitive material contains a hydrophilic binder on the support, and a non-light-sensitive layer containing a hydrophilic binder is provided on the side opposite to a light-sensitive layer side, with the support being between the layers, and the light-sensitive layer contains the photosensitive silver halide;

(2) The heat-developable color photographic light-sensitive material according to the above (1), which satisfies the condition (A);

(3) The heat-developable color photographic light-sensitive material according to the above (1), which satisfies the condition (B);

(4) The heat-developable silver halide color photographic light-sensitive material according to the above (3), wherein the main component of the hydrophilic binder is gelatin;

(5) The heat-developable silver halide color photographic light-sensitive material according to the above (4), wherein the amount of the gelatin contained in the light-sensitive layer is within the range of 5 to 20 g/m², and the amount of the gelatin contained in the non-light-sensitive layer provided on the side opposite to the light-sensitive layer side, with the support being between the layers, is within the range of 3 to 20 g/m²;

(6) A color image-forming method, comprising:

heating the silver halide photographic light-sensitive material of any of the above (1) to (5) at a temperature of 130 to 200° C. for 3 to 30 seconds, thereby forming an image; and

(7) The method according to the above (6), further comprising:

producing an image signal by reading, by photoelectric means, the image formed on the light-sensitive material, and

obtaining a color image visualized on another display device or output medium, based on the image signal.

Herein, the phrase “the main component of the hydrophilic binder is gelatin” means that the amount of the gelatin is preferably 70 mass % or more in the hydrophilic binder.

The present invention is explained in detail below.

The glass transition temperature of the support for use in one embodiment of the present invention according to the above-mentioned item (1), provided that it is limited to one satisfying only the condition (B), and item (3), which is referred to as a first embodiment hereinafter, is generally within the range of 65 to 400° C. The glass transition temperature is preferably within the range of 120 to 350° C., as in another embodiment of the present invention according to the above-mentioned item (1), provided that it is limited to one satisfying only the condition (A), and item (2), which is referred to as a second embodiment hereinafter. The glass transition temperature is more preferably within the range of 120 to 300° C., and particularly preferably within the range of 140 to 250° C. in both of the first and second embodiments in the present invention. Next, representative examples of the polymer that can be used in the support for use in the present invention are given below when the polymer is a homopolymer, but it should be understood that the present invention is not restricted to these examples.

| | |
|---|---|
| Polyethylene terephthalate (PET) | Tg = 76° C. |
| Polyphenylenesulfide (PPS) | Tg = 90° C. |
| Syndiotactic polystyrene (SPS) | Tg = 100° C. |
| Polymethyl methacrylate (PMMA) | Tg = 105° C. |
| Polyethylene naphthalate (PEN) | Tg = 119° C. |
| Polycarbonate (PC) | Tg = 140˜150° C. |
| Polysulfone (PSU) | Tg = 190° C. |
| Polyarylate (PAR) | Tg = 193˜215° C. |
| Polyethersulfone (PES) | Tg = 223˜230° C. |
| Polyparabanic acid (PPA) | Tg = 290° C. |
| Thermoplastic polyimide (TPI) | Tg = 250° C. |
| Polyamideimide (PAI) | Tg = 285˜350° C. |
| Polyetheretherketone (PEEK) | Tg = 143° C. |
| Polyetherimide (PEI) | Tg = 216° C. |
| Full-aromatic polyamide (APA) | Tg = 275° C. |
| Half-aromatic polyamide | Tg = 125˜140° C. |

Among these polymers, particularly excellent polymers are described below, though it should be understood that the present invention is not restricted to these.

Among the polymers listed above, some polyethylene terephthalate (PET) and polyethylene naphthalate (PEN) are already used in silver halide color light-sensitive materials. The details are described, for example, in “Principles of Photographic Science and Engineering-Silver Salt Photography (revised edition)”, edited by The Photographic Society of Japan, Corona Publishing Co., Ltd. (1998).

Polycarbonate (PC) is a common polymer as engineering plastics in electronic parts, and the like. In addition to excellent physical properties, this polymer has excellent properties such as good heat resistance and weather resistance, small percentage of water absorption, and good dimension stability (accuracy) at the time of forming. Despite such properties, this polymer could not be used as a support of color photographic light-sensitive materials because the chemical resistance of this polymer is so insufficient that problems occur at the time of manufacture of the light-sensitive materials or at the time of processing the light-sensitive materials with liquids (processing solutions). To the contrary, this polymer was found to be advantageous because the excellent heat resistance can be fully utilized in heat-developable light-sensitive materials like the light-sensitive material of the present invention that is free from such problems.

Polysulfone (PSU) and polyethersulfone (PES) have excellent mechanical properties, high heat resistance, and high chemical resistance because of the presence of a sulfone or ether group linked to the main-chain benzene ring, and PSU and PES are very preferable as a support of a light-sensitive material for heat development.

Polyarylate (PAR) is a polycondensation-type polymer made from a divalent phenol and an aromatic dicarboxylic acid and is also called full-aromatic polyester. In particular, high heat resistance and weather resistance are the properties characteristic of this polymer. This polymer is also preferable as a support for a heat-developable light-sensitive material. Among polyarylates, a transparent amorphous polymer, which is obtained by a polycondensation of bisphenol A and a mixture of phthalic acids made up of terephthalic acid and isophthalic acid, and which is exemplified, for example, by U Polymer (trade name, manufactured by Unitika Ltd.), is particularly preferable.

Besides, the polyester copolymer, which is described in JP-A-11-7100 and is composed mainly of naphthalene dicarboxylic acid, can also be used as a support for use in the present invention. As examples of this polyester copolymer, comonomers thereof are listed below, though it should be understood that the present invention is not restricted to these examples.

| | |
|---|---|
| 2,6-naphthalene dicarboxylic acid/ethylene | Tg = 155° C. |
| glycol/bisphenol A (100/25/75) | |
| 2,6-naphthalene dicarboxylic acid/ethylene | Tg = 150° C. |
| glycol/cyclohexanedimethanol/bisphenol A | |
| (100/25/25/50) | |
| 2,6-naphthalene dicarboxylic acid/neopentyl | Tg = 145° C. |
| glycol/ethylene glycol (100/70/30) | |
| 2,6-naphthalene dicarboxylic acid/ethylene | Tg = 130° C. |
| glycol/biphenol (100/20/80) | |

Polyimide is by nature a polymer having very good heat resistance. The problem of this polymer is that its thermal forming requires a very high temperature to be maintained and thus presents disadvantages in terms of manufacturing facility or energy consumption. In order to provide an easily usable polyimide-based polymer having thermal formability and yet retaining sufficient heat resistance, thermoplastic polyimide (TPI), polyamideimide (PAI), and polyetherimide (PEI) were developed. In these polymers, a group, such as an amido group, an ether group, or the like, is introduced into its molecule so as to lower Tg to a point required for securing formability and film-forming capability. Since other physical properties are also excellent, these plastics are also preferable, as a support of a heat-developable color light-sensitive material.

Examples of TPI include Auram, trade name, manufactured by Mitsui Chemicals, Inc.; examples of PAI include Torlon, trade name, manufactured by Amoco Chemicals Corp.; and examples of PEI include Ultem, trade name, manufactured by General Electric Company.

A polyamide, which is represented by nylon (trade name), is a generic name of a linear polymer having an amido group in the molecular structure thereof. Most of these polymers are crystalline due to intermolecular hydrogen bonds, and the like. Generally, a crystalline polymer cannot be used as a support of a light-sensitive material because high transparency is required for such support. However, it is known that an amorphous polymer can be obtained by the introduction of an aromatic ring into the molecular chain. In addition, it has become possible to produce a polyamide, which has high transparency and heat resistance, by the selection of structure and polymerizing ratio of the aromatic ring.

As such heat-resistant polyamide, a full-aromatic polyamide (APA), represented, for example, by Aramid (trade name), is known. Among these polyamides, polyparaphenyleneterephthalamide (PPTA) in particular can be advantageously used as a support of a heat-developable color photographic light-sensitive material.

Besides, generally, the forming of Aramid is difficult. For this reason, a half-aromatic polyamide, in which a basic unit is made up of a combination of a molecular unit containing an aromatic ring and of a molecular unit containing no aromatic ring, is also useful. Examples of this polyamide include Arlen A, trade name, manufactured by Mitsui Chemicals, Inc.

Further, a blend of plural polymers is also advantageously used as the support in the present invention. Examples of the polymer blend are given below, though it should be understood that the present invention is not restricted to these examples.

| | |
|---|---|
| Polyarylate (PAR)/polyethylene naphthalate (PEN) = | Tg = 138° C. |
| 15/85 | |
| Polyarylate (PAR)/polycarbonate (PC)/polyethylene | Tg = 140° C. |
| naphthalate (PEN) = 10/10/80 | |

Tg, as used herein, can be obtained by use of differential scanning calorimetry (DSC). The procedure is as follows. A sample in an amount of 10 mg is heated to 300° C. at a heating rate of 20° C./minute in a nitrogen stream, rapidly cooled to room temperature, and again heated at a heating rate of 20° C./minute. Tg can be obtained as an arithmetic mean of the temperature at which departure from a base line starts and the temperature at which return to a new base line is made.

Such a film can be formed by a method generally called melt extrusion (melt method) or by a method in which a solution of a polymer in an organic solvent is spread by being flown (solvent method). A melt extrusion method is particularly preferable in environmental terms.

More specifically, the melt extrusion comprises extruding a polymer melted by being heated, and then cooling and solidifying the extruded polymer by cooling. The extruder may be a single-screw extruder or a twin-screw extruder. Further, the extruder may be of a type with or without vent. The extruder is preferably equipped with a suitable mesh filter for such purposes as pulverization or removal of secondary flocculated particles and removal of dusts or foreign matters.

Although the extruding conditions are not particularly limited and selected depending on various conditions, preferably the extrusion is carried out at a temperature falling within the range between the melting point of the polymer material and a temperature 50° C. above the melting point, using a T-die, or the like.

After the extrusion, the preform (raw film sheet, raw yard good film sheet) thus obtained is solidified by cooling. Examples of the cooling medium that can be used include a gas, a liquid, and metal rollers. When metal rollers, or the like are used, means, such as air knife, air chamber, a touch roller, or electrostatic charge impression, is effective in the prevention of uneven thickness or undulation.

The temperature for solidification by cooling is generally in the range between 0° C. and a temperature higher by 30° C. than the glass transition temperature of the raw film sheet, and preferably in the range between a temperature lower by 50° C. than the glass transition temperature and the glass transition temperature. The cooling rate may be selected appropriately from the range of 200 to 3° C./second. The raw film sheet thus obtained has a thickness generally within the range of 10 to 5000 μm.

After cooling and solidification, the raw film sheet is uniaxially or biaxially stretched. In the case of biaxial stretching, the raw film sheet may be stretched longitudinally and transversely at the same time, or alternatively, the raw film sheet may be stretched successively in an arbitrary order. The stretching may be performed in one stage or in multiple stages.

The stretching method may be selected from various methods such as a method by means of a tenter, a method in which stretching is made between rollers, a method in which stretching is made by bubbling utilizing the pressure of a gas, and a method by rolling. Any one of these methods or a combination thereof may be employed appropriately. The stretching temperature lies generally between the glass transition temperature and melting point of the raw film sheet.

However, in the case of successive stretching or multistage stretching, it is preferable to set the stretching temperature to a temperature between the glass transition temperature and the crystallization temperature for the first stage and to set the stretching temperature to a temperature between the glass transition temperature and the melting point for a stage that comes after. The stretching rate is generally within the range of 1×10 to 1×10⁷%/minute and preferably within the range of 1×10³ to 1×10⁷%/minute.

In this case, the areal stretching ratio is generally 8 times or more and preferably 10 times or more.

It is preferable to subject the stretched film obtained by the above-described stretching procedure to thermal fixing, in order to further increase the dimension stability at high temperatures, heat resistance, and strength balance within the film plane. The thermal fixing can be carried out according to a usual manner. For example, the stretched film, which is in a state of tension, relaxation, or a limited contraction, is kept at a temperature in the range between the glass transition temperature and melting point of the film, preferably at a temperature in the range between the surrounding atmospheric temperature and the melting point, for 0.5 to 1880 seconds. The thermal fixing may be carried out two or more times by changing the temperature conditions. It is also preferable to carry out the thermal fixing in the atmosphere of an inert gas such as argon, nitrogen, and the like. Besides, in order to obtain a film having a reduced thermal shrinkage, it is preferable that any one step of the thermal fixing is performed in a state of limited contraction. The proportion of the limited contraction is generally 20% or less, preferably 15% or less, in the longitudinal direction and/or transverse direction.

A film having excellent transparency can be obtained, by setting, for example, the stretching and thermal fixing conditions such that the absolute value of the birefringence, i.e., |Δn|, of the film is 40×10⁻³ or less.

The following conventionally known methods can be employed to bond, on the surface of the support for use in the present invention, the various coating layers for heat-developable light-sensitive material, for example, a silver halide emulsion layer, an ahtihalation layer, an intermediate layer, a backing layer and the like. Specifically, there are the following two methods:

(1) A method, in which surface activating treatment, such as chemical treatment, mechanical treatment, corona discharge treatment, flame treatment, ultraviolet treatment, high-frequency treatment, glow discharge treatment, activated plasma treatment, laser treatment, mixed acid treatment or ozone oxidation treatment, is carried out, and then a coating layer is directly applied, to obtain adhesive force; and

(2) A method, in which after the above surface treatment is once carried out, or without subjecting to the above surface treatment, an undercoating layer is formed, and a coating layer is applied onto the undercoating layer. (For example, U.S. Pat. Nos. 2,698,241, 2,764,520, 2,864,755, 3,462,335, 3,475,193, 3,143,421, 3,501,301, 3,460,944, and 3,674,531, U.K. Patent Nos. 788,365, 804,005, and 891,469, JP-B-48-43122, JP-B-51-446 (“JP-B” means examined Japanese patent publication), and the like).

These surface treatments each are assumed to have the effects of: forming a polar group in some degree on the surface of the support which is originally hydrophobic, and increasing the crosslinking density of the surface, thereby increasing the adhesive force. As a result, it is assumed that, for example, the affinity of components contained in a solution of the undercoating layer to the polar group is increased and the fastness of the bonded surface is increased, thereby improving adhesion between the undercoating layer and the surface of the support.

As to the construction of the undercoating (primer) layer, various improvements have been made, including the followings. In a double-layer system, a layer, which has good adhesion to the support (this layer is hereinafter referred to as the 1st primer layer), is formed as the first layer and this layer is overcoated with a resin, which has affinity and good adhesion to a photographic layer, as a second layer (this layer is hereinafter referred to as the 2nd primer layer). On the other hand, in a single-layer system, a layer of a resin, which has both of the hydrophobic group and the group having the affinity, is formed as a single layer.

Among the above-mentioned surface treatments (1), the corona discharge treatment is the most known treatment and can be performed by any of the conventionally known methods, such as those described in, for example, JP-B-48-5043, JP-B-47-51905, JP-A-47-28067, JP-A-49-83767, JP-A-51-41770, JP-A-51-131576, and the like. The discharge frequency is generally 50 Hz to 5000 kHz and preferably 5 kHz to hundreds of kHz. If the discharge frequency is too small, a stable discharge cannot be obtained and pinholes are undesirably formed in the article to be treated. On the other hand, if the discharge frequency is too high, a special device is required for impedance matching and the cost for the device is disadvantageously high.

In many cases, a glow discharge treatment, which is the most effective surface treatment, can be performed by any of the conventionally known methods, such as those described in, for example, JP-B-35-7578, JP-B-36-10336, JP-B-45-22004, JP-B-45-22005, JP-B-45-24040, JP-B-46-43480, U.S. Pat. Nos. 3,057,792, 3,057,795, 3,179,482, 3,288,638, 3,309,299, 3,424,735, 3,462,335, 3,475,307, and 3,761,299, U.K. Patent No. 997,093, JP-A-53-129262, and the like.

As a condition of the glow discharge treatment, generally the pressure is 0.005 to 20 Torr and preferably 0.02 to 2 Torr. If the pressure is too low, the effect of the surface treatment is lessened. On the other hand, if the pressure is too high, an excessively large electric current will flow and sparks tend to occur. Therefore, there is a risk of danger and the article to be treated may be destroyed. The discharge is generated by applying a high voltage between one or more pairs of metal plates or metal rods, which are disposed at a certain space, in a vacuum tank. Although the voltages may vary depending on the compositions and pressures of the atmospheric gases, generally a stable and regular glow discharge occurs at a voltage in the range between 500 and 5000V in the above-mentioned pressure range. From the standpoint of raising the adhesion, a particularly preferred voltage range is 2000 to 4000V.

As can be seen in the conventional technique, the discharge frequency is generally between a direct current and frequencies up to thousands of MHz, preferably 50 Hz to 20 MHz. As to the intensity of the discharge treatment, it is generally 0.01 to 5 kV·A·minute/m², and preferably 0.15 to 1 kV·A·minute/m², from the standpoint of obtaining a desired adhesion performance.

Next, the methods, which provide an undercoating layer, described in the above (2) are explained. These methods are intensively investigated. For the first undercoating (subbing) layer according to the multilayer method, the use of the various polymers have been studied: examples are copolymers produced by using monomers selected from vinyl chloride, vinylidene chloride, butadiene, methacrylic acid, acrylic acid, itaconic acid, maleic anhydride, and the like as a starting material; and other polymers, such as polyethylene imine, epoxy resins, grafted gelatins, and nitrocellulose. Further, the use of gelatin and the resulting properties have been studied as a main polymer for the second subbing layer.

On the other hand, in the single layer method, a method in which good adhesion can be achieved by swelling a support, followed by an interfacial mixing of the swollen support with a hydrophilic subbing polymer, is often used.

Examples of the hydrophilic subbing polymer that can be used in the present invention include a water-soluble polymer, a cellulose ester, a latex polymer, a water-soluble polyester, and the like. Examples of the water-soluble polymer include gelatin, gelatin derivatives, casein, agar-agar, sodium alginate, starch, polyvinyl alcohol, a polyacrlylic acid-based copolymer, and a maleic anhydride-based copolymer. Examples of the cellulose ester include carboxymethyl cellulose and hydroxyethyl cellulose. Examples of the latex polymer include a vinyl chloride-containing copolymer, a vinylidene chloride-containing copolymer, an acrylic acid ester-containing copolymer, a vinyl acetate-containing copolymer, and a butadiene-containing copolymer. Among these, gelatin is most preferred.

Further, examples of the compound that can be used to swell a support for use in the present invention include resorcin, chlororesorcin, methylresorcin, o-cresol, m-cresol, p-cresol, phenol, o-chlorophenol, p-chlorophenol, dichlorophenol, trichlorophenol, monochloroacetic acid, dichloroacetic acid, trifluoroacetic acid, and chloral hydrate.

In the undercoat layer usable in the present invention, various polymer hardening agents can be used.

As the polymer hardening agent, chrome salts (e.g. chrome alum), aldehydes (e.g. formaldehyde and glutaraldehyde), isocyanates, active halogen compounds (e.g. 2,4-dichloro-6-hydroxy-s-triazine), epichlorohydrin resins, and the like, can be mentioned.

In the undercoat layer in the present invention, SiO₂, TiO₂, inorganic fine particles, or polymethyl methacrylate copolymer fine particles (1 to 10 μm) may be contained as a matting agent.

In addition to the above, a subbing solution, if necessary, may contain various kinds of additives, such as a surfactant, an antistatic agent, an antihalation agent, a coloring dye, a pigment, a coating aid, and an antifoggant. In the present invention, when an undercoating solution for the 1st primer layer is used, there is no need at all to incorporate an etching agent, such as resorcinol, chloral hydrate, or chlorophenol, into the solution for forming primer layer. However, if required, an etching agent such as one selected form those listed above may be incorporated in the undercoat solution.

The undercoating solution that can be used in the present invention can be coated on a support, by any one of generally well-known methods, such as a dip coating, an air-knife coating, a curtain coating, a roller coating, a wirebar coating, a gravure coating, and an extrusion coating using a hopper, as described in the specification of U.S. Pat. No. 2,681,294. Furthermore, according to circumstances, two layers or higher multilayers can be simultaneously coated by a method as described, for example, in the specifications of U.S. Pat. Nos. 2,761,791, 3,508,947, 2,941,898, and 3,526,528, and by Yuji Harasaki, in “Coating Technology (Coating Kogaku)” p. 253 (published by Asakura Shoten, 1973).

In a photographic light-sensitive material for shooting, a so-called light-piping phenomenon, in which visible light is transmitted from the edge portion of the film to the inside and the light-sensitive material shielded from light is fogged by light, is a problem. In order to overcome the light-piping, it is preferable that the film itself or the primer layer is dyed. As for the color tone (hue) of the dye to be used for dyeing films, dyeing in gray is preferable in view of general characteristics of light-sensitive materials. A dye, which has excellent resistance to heat within the film-forming temperature range, and excellent compatibility with a polymer of the main component in the film, is preferable. In this regard, use can be preferably made of commercially available dyes, such as Diaresin (trade name) manufactured by Mitsubishi Chemicals Industries Ltd., or Kayaset (trade name) manufactured by Nippon Kayaku Co., Ltd. From the standpoint of heat resistance in particular, an anthraquinone-series dye can be mentioned. For example, the anthraquinone-series dye described in JP-A-8-122970 and the like is preferable for use.

In the heat-developable photographic light-sensitive material of the present invention, it is preferable that the light-sensitive material has a light-sensitive layer containing a silver halide emulsion on one side of the support and has a backing layer composed of a non-light-sensitive layer containing a hydrophilic binder on another side of the support. Specifically, as described in JP-A-5-333471, it is preferable to coat a gelatin layer, or a binder layer composed mainly of gelatin, on the side of the support opposite to the light-sensitive layer side. Further, as described in JP-A-5-232625, the gelatin layer may be overcoated with a layer comprising a polymer.

Generally, the hydrophilic binder contained in the light-sensitive layer is composed mainly of gelatin and the coating amount of the gelatin in the light-sensitive layer is in the range of 5 to 20 g/m². In this case, the amount of gelatin, which is contained in the backing layer present on the side opposite to the light-sensitive layer side with the support therebetween, is preferably in the range of 3 to 20 g/m². It is particularly preferable that the amount of gelatin in the backing layer is in the range of 5 to 15 g/m².

In the present invention, preferred binders for a backing layer are transparent or semitransparent and generally colorless. Examples include natural polymer synthetic resins, polymers, copolymers and other media forming films: for example, gelatin, gum arabic, poly(vinyl alcohol), hydroxyethyl cellulose, cellulose acetate, cellulose acetate butylate, poly(vinylpyrrolidone), casein, starch, poly(acrylic acid), poly(methylmethacrylic acid), poly(vinyl chloride), poly(methacrylic acid), styrene/maleic acid anhydride copolymer, styrene/acrylonitrile copolymer, styrene/butadiene copolymer, poly(vinylacetal)s (e.g., poly(vinylformal) and poly(vinylbutyral)), polyesters, polyurethanes, phenoxy resin, poly(vinylidene chloride), polyepoxides, polycarbonates, poly(vinyl acetate), cellulose esters and polyamides. The binder may be formed by coating a solution of the binder dissolved in water or an organic solvent, or an emulsion.

In the present invention, the backing layer of the light-sensitive material may contain a matting agent in order to improve the transportability. Generally, the matting agent is composed of fine particles of a water-insoluble organic or inorganic compound. Any matting agent that is well known in the art can be used. Examples of the matting agent include organic matting agents described, for example, in U.S. Pat. Nos. 1,939,213, 2,701,245, 2,322,037, 3,262,782, 3,539,344, 3,767,448, and inorganic matting agents described, for example, in U.S. Pat. Nos. 1,260,772, 2,192,241, 3,257,206, 3,370,951, 3,523,022, 3,769,020. Specific examples of the organic compound that can be advantageously used as the matting agent include water-dispersible vinyl polymers, such as polymethyl acrylate, polymethyl methacrylate, polyacrylonitrile, acrylonitrile/α-methylstyrene copolymers, polystyrene, styrene/divinylbenzene copolymers, polyvinyl acetate, polyethylene carbonate, and polytetrafluoroethylene; cellulose derivatives, such as methyl cellulose, cellulose acetate, and cellulose acetatepropionate; starch derivatives, such as carboxy-modified starch, carboxynitrophenyl-modified starch, and urea/formaldehyde/starch reaction products; gelatin hardened by a known hardener; and gelatin made into fine capsular hollow particles by coacervation-hardening of gelatin.

Specific examples of the inorganic compound that can be advantageously used as the matting agent include silicon dioxide, titanium dioxide, magnesium dioxide, aluminum oxide, barium sulfate, calcium carbonate, silver chloride desensitized by a known method, silver bromide desensitized by a known method, glass, diatomaceous earth, and the like. If necessary, the matting agent may comprise a mixture of different kinds of substances listed above. The size and shape of the matting agent are not particularly limited, and the matting agent having any particle diameter may be used. In the practice of the present invention, it is preferable to use the matting agent having a particle diameter of 0.1 to 30 μm. The particle size distribution of the matting agent may be narrow or broad. On the other hand, the matting agent exerts a significant influence on the haze and surface gloss of the light-sensitive material. Therefore, it is preferable to adjust the particle diameter, shape, and particle size distribution to required values, by controlling the manufacture of the matting agent or by blending plural kinds of matting agents.

In the present invention, the Beck smoothness value indicative of the mat surface of the backing layer is preferably 3000 seconds or less, more preferably 250 seconds or less but 10 seconds or more, and further preferably 180 seconds or less but 50 seconds or more.

In the present invention, the backing layer may contain a dye for such purposes as antihalation. In the present invention, when a dye for prevention of halation is used, the dye may be any compound, with the proviso that the compound exhibits the target absorption in the desired wavelength range so that a desirable shape of absorbance spectrum of the backing layer is obtained. Examples of the dye include the compounds described in JP-A-7-13295, the compounds described in U.S. Pat. No. 5,380,635; the compounds described in JP-A-2-68539, from lower left column, line 1, on page 13 to lower left column, line 9, on page 14; and the compounds described in JP-A-3-24539, from lower left column on page 14 to lower right column on page 16, though it should be understood that the present invention is not restricted to these compounds.

To the backing layer in the present invention, a magnetic recording layer, as described in JP-A-4-124634, JP-A-5-40321, JP-A-6-35092, and JP-A-6-31875 can be provided. The magnetic recording layer that can be used in the present invention refers to a layer formed by coating a base with an aqueous or organic solvent-based coating solution containing magnetic particles dispersed in a binder.

As the magnetic particles usable in the present invention, use can be made, for example, of a ferromagnetic iron oxide, such as γFe₂O₃, Co-coated γFe₂O₃, Co-coated magnetite, Co-containing magnetite, ferromagnetic chromium dioxide, a ferromagnetic metal, a ferromagnetic alloy, hexagonal Ba ferrite, Sr ferrite, Pb ferrite, and Ca ferrite. A Co-coated ferromagnetic iron oxide, such as Co-coated γFe₂O₃, is preferable. The shape may be any of a needle shape, a rice grain shape, a spherical shape, a cubic shape, a sheet shape, and the like. The specific surface area is preferably 20 m²/g or more, and particularly preferably 30 m²/g or more, in terms of S_{BET}. The saturation magnetization ((s) of the ferromagnetic material is preferably 3.0×10⁴ to 3.0×10⁵ A/m, and particularly preferably 4.0×10⁴ to 2.5×10⁵ A/m. The ferromagnetic particles may be surface-treated with silica and/or alumina or an organic material. The surface of the magnetic particles may be treated with a silane coupling agent or a titanium coupling agent, as described in JP-A-6-161032. Further, magnetic particles whose surface is coated with an inorganic or organic material, as described in JP-A-4-259911 and JP-A-5-81652, can be used.

As the binder that can be used for the magnetic particles, as described in JP-A-4-219569, a thermoplastic resin, a thermosetting resin, a radiation-setting resin, a reactive resin, an acid-degradable polymer, an alkali-degradable polymer, a biodegradable polymer, a natural polymer (e.g. a cellulose derivative and a saccharide derivative), and a mixture of these can be used. The above resins have a Tg of −40 to 300° C. and a weight-average molecular weight of 2,000 to 1,000,000. Examples include vinyl copolymers, cellulose derivatives, such as cellulose diacetates, cellulose triacetates, cellulose acetate propionates, cellulose acetate butylates, and cellulose tripropionates; acrylic resins, and polyvinyl acetal resins; and gelatin is also preferable. Cellulose di(tri)acetates are particularly preferable. To the binder may be added an epoxy, aziridine, or isocyanate crosslinking agent, to harden the binder. Examples of the isocyanate crosslinking agent include isocyanates, such as tolylene diisocyanate, 4,4′-diphenylmethane diisocyanate, hexamethylene diisocyanate, and xylylene diisocyanate; reaction products of these isocyanates with polyalcohols (e.g. a reaction product of 3 mol of tolylene diisocyanate with 1 mol of trimethylolpropane), and polyisocyanates produced by condensation of these isocyanates, which are described, for example, in JP-A-6-59357.

The method of dispersing the foregoing magnetic material in the foregoing binder is preferably one described in JP-A-6-35092, in which method use is made of a kneader, a pin-type mill, an annular-type mill, and the like, which may be used alone or in combination. A dispersant described in JP-A-5-88283 and other known dispersants can be used. The thickness of the magnetic recording layer is generally 0.1 to 10 μm, preferably 0.2 to 5 μm, and more preferably 0.3 to 3 μm. The weight ratio of the magnetic particles to the binder is preferably from (0.5:100) to (60:100), and more preferably from (1:100) to (30:100). The coating amount of the magnetic particles is generally 0.005 to 3 g/m², preferably 0.01 to 2 g/m², and more preferably 0.02 to 0.5 g/m². The transmission yellow density of the magnetic recording layer is preferably 0.01 to 0.50, more preferably 0.03 to 0.20, and particularly preferably 0.04 to 0.15. The magnetic recording layer can be provided to the undersurface of the photographic base by coating or printing through all parts or in a striped fashion.

To apply the magnetic recording layer, use can be made of an air doctor, blade, air knife, squeezing, impregnation, reverse roll, transfer roll, gravure, kiss, cast, spraying, dipping, bar, extrusion, or the like. A coating solution described, for example, in JP-A-5-341436 is preferable.

The magnetic recording layer may be provided with functions, for example, of improving lubricity, of regulating curling, of preventing electrification, of preventing adhesion, and of abrading a head, or it may be provided with another functional layer that is provided with these functions. An abrasive in which at least one type of particles comprises aspherical inorganic particles having a Moh's hardness of 5 or more, is preferable. The aspherical inorganic particles preferably comprise a fine powder of an oxide, such as aluminum oxide, chromium oxide, silicon dioxide, and titanium dioxide; a carbide, such as silicon carbide and titanium carbide; diamond, or the like. The surface of these abrasives may be treated with a silane coupling agent or a titanium coupling agent. These particles may be added to the magnetic recording layer, or they may form an overcoat (e.g. a protective layer and a lubricant layer) on the magnetic recording layer. As a binder that can be used at that time, the above-mentioned binders can be used, and preferably the same binder as used in the magnetic recording layer is used. Light-sensitive materials having a magnetic recording layer are described in U.S. Pat. Nos. 5,336,589, 5,250,404, 5,229,259, and 5,215,874, and European Patent No. 466,130.

Further, in the present invention, an antistatic agent is preferably used. To use the antistatic agent, it is preferable to provide an antistatic layer as one layer of the constitutional layers of the backing layer. As the antistatic agent, polymers containing a carboxylic acid, a carboxylate, or a sulfonate; cationic polymers, and ionic surface-active compounds can be mentioned. Most preferable antistatic agents are fine particles of at least one crystalline metal oxide selected from the group consisting of ZnO, TiO₂, SnO₂, Al₂O₃, In₂O₃, SiO₂, MgO, BaO, MoO₃, and V₂O₅, and having a specific volume resistance of 10⁷ Ωcm or less, and more preferably 10⁵ Ωcm or less and a particle size of 0.001 to 1.0 μm, or fine particles of their composite oxides (Sb, P, B, In, S, Si, C, and the like); as well as fine particles of the above metal oxides in the form of a sol, or fine particles of composite oxides of these. The content thereof in the light-sensitive material is preferably 5 to 500 mg/m², and particularly preferably 10 to 350 mg/m². The ratio of the amount of the electroconductive crystalline oxide or its composite oxide to the amount of the binder is preferably from 1/300 to 100/1, and more preferably from 1/100 to 100/5.

(Emulsion and Additives for an Emulsion)

The silver halide that can be used in the light-sensitive material of the present invention may be any of silver iodobromide, silver bromide, silver chlorobromide, silver iodochloride, silver chloride, and silver iodochlorobromide. The grain size of the silver halide is preferably 0.1 to 2 μm, and particularly preferably 0.2 to 1.5 μm, in terms of the diameter of a sphere having a volume equivalent to an individual grain's volume. Besides the use as photosensitive silver halide grains described above, these silver halides may also be used as non-photosensitive silver halide grains without chemical sensitization or the like.

The shape of the silver halide grain may be selected from a regularly structured crystal such as a cube, octahedron, or tetradecahedron, and a tabular shape such as a hexagon or rectangle. Among these shapes, a tabular shape, which has an aspect ratio, i.e., a value obtained by dividing the diameter of the projected grain (e.g. the diameter of a circle having an area equivalent to that of an individual grain) by the grain thickness, of 2 or more, more preferably 8 or more, and further preferably 20 or more, is preferable. It is preferable to use an emulsion in which these tabular grains account for 50% or more, more preferably 80% or more, and further preferably 90% or more, of the total projected area of all the grains.

The thicknesses of these tabular grains are preferably 0.3 μm or less, more preferably 0.2 μm or less, and most preferably 0.1 μm or less.

In addition, grains, which have thicknesses less than 0.07 μm and have even higher aspect ratios, as described in U.S. Pat. Nos. 5,494,789, 5,503,970, 5,503,971, 5,536,632, and the like, can also be used preferably.

Furthermore, tabular grains, which are rich in silver chloride and have (111) plane as a main face, as described in U.S. Pat. Nos. 4,400,463, 4,713,323, 5,217,858, and the like; and tabular grains, which are rich in silver chloride and have (100) plane as a main face, as described in U.S. Pat. Nos. 5,264,337, 5,292,632, 5,310,635, and the like, can also be used preferably.

Examples in which these silver halide grains are actually used are described in JP-A-9-274295, JP-A-9-319047, JP-A-10-115888, JP-A-10-221827, and the like. The silver halide grains that can be used in the present invention are preferably so-called monodispersed grains having a uniform grain size distribution. As an indicator of the monodispersity, a variation coefficient, which is obtained by dividing the standard deviation of the grain size distribution by an average grain diameter, is preferably 25% or less and more preferably 20% or less. It is also preferable that the halogen composition among grains is homogeneous.

The halogen composition inside the silver halide grain for use in the present invention may be homogeneous. Alternatively, a site having a different halogen composition may be intentionally introduced into the grain. In particular, for the purpose of obtaining a high sensitivity, a grain having a laminate structure, which is comprised of a core and a shell each having a different halogen composition, is preferably used. It is also preferable to further grow the grain after a region having a different halogen composition is introduced so that a dislocation line is intentionally introduced. Further, it is also preferable to epitaxially join a guest crystal, which has a different halogen composition, to an apex or side of a host grain formed.

It is also preferable that the inside of the silver halide grain for use in the present invention is doped with a multivalent transition metal ion or a multivalent anion, as an impurity. In particular, in the case of the former, preferred examples that are employed include complexes having, as a central metal, an element of iron group, such as a halogeno complex, a cyano complex, a complex having an organic ligand.

As a method for preparing the silver halide grains for use in the present invention, known method described, for example, by P. Glafkides in “Chemie et Phisique Photographique,” Paul Montel, 1967; by G. F. Duffin in “Photographic Emulsion Chemistry,” Focal Press, 1966; or by V. L. Zelikman et al. in “Making and Coating of Photographic Emulsion,” Focal Press, 1964, can be referred to. That is, any of pH regions among the acid process, the neutral process, the ammonia process, and the like can be used to prepare silver halide grains. Further, to supply a water-soluble silver salt solution and a water-soluble halogen salt solution that are reaction solutions, any of the single-jet method, the double-jet method, a combination thereof, and the like can be used. The controlled double-jet method, can also be used preferably, wherein the addition of reaction solutions are controlled, to keep the pAg during the reaction constant to a targeted value. A method in which the pH of the reaction liquid during the reaction is kept constant can also be used. In the step for forming grains, a method in which the solubility of the silver halide is controlled by changing the temperature, pH, or pAg of the system, can be used; and a thioether, a thiourea, a rhodanate, and the like can be used as a silver halide solvent. Examples of these are described, for example, in JP-B-47-11386, and JP-A-53-144319.

Generally, the preparation of the silver halide grains for use in the present invention is carried out by feeding a solution of a water-soluble silver salt, such as silver nitrate, and a solution of a water-soluble halogen salt, such as an alkali halide, into an aqueous solution containing a water-soluble binder dissolved therein, such as gelatin, under controlled conditions. After the formation of the silver halide grains, the excess water-soluble salts are preferably removed. For example, the noodle water-washing method, in which a gelatin solution containing silver halide grains are made into a gel, and the gel is cut into a string-shape, then the water-soluble salts are washed away using a cold water; and the a so-called spectrally sensitizing dye providing grains of silver halide with sensitivity in its wavelength range of light absorbance, by adsorbing onto the grains of silver halide. Examples of such a dye include cyanine dyes, merocyanine dyes, composite cyanin dyes, composite merocyanine dyes, halopolar dyes, hemicyanine dyes, styryl dyes, and hemioxonol dyes. These spectrally sensitizing dyes may be used singly or in combination; and also, it is preferred that these are used in combination with a supersensitizer.

The coating amount of the light-sensitive silver halide (emulsion) used in the present invention is generally in the range of 0.05 mg to 15 g/m², preferably 0.1 to 8 g/m², in terms of silver.

In the silver halide emulsion for use in the present invention, various stabilizers can be incorporated for the purpose of preventing fogging, or for the purpose of improving stability at storage. As a preferable stabilizer, nitrogen-containing heterocyclic compounds, such as azaindenes, triazoles, tetrazoles, and purines; mercapto compounds, such as mercaptotetrazoles, mercaptotriazoles, mercaptoimidazoles, and mercaptothiadiazoles, can be mentioned. Particularly, among these, triazoles or mercaptoazoles that have an alkyl group having 5 or more carbon atoms, or have an aromatic group, as a substituent(s) in their molecules, prevent fogging at the time of the heat development, and in a certain case, improve developability of an exposed area, so that these compounds exhibit remarkable effects on providing high-discrimination. As additives for photography that can be used in the silver halide emulsion according to the present invention, those described in Research Disclosures (hereinafter abbreviated to as RD) No. 17643 (December 1978), RD No. 18716 (November 1979), RD No. 307105 (November 1989), and RD No. 38957 (September 1996) can be preferably used.

The timing when the antifoggant or the stabilizer is added to the silver halide emulsion, may be at any stage in the preparation of the emulsion. The addition to the emulsion can be carried out at any time, singly or in combination, of after the completion of the chemical sensitization and during the preparation of a coating solution, at the time of the completion of the chemical sensitization, during the chemical sensitization, prior to the chemical sensitization, after the completion of the grain formation and before desalting, during the grain formation, or prior to the grain formation.

The amount of these antifogging agents or stabilizers to be added varies widely in accordance with the halogen composition of the silver halide emulsion and the purpose, and it is generally in the range of 10⁻⁶ to 10⁻¹ mol, and preferably 10⁻⁵ to 10⁻² mol, per mol of the silver halide.

The above-mentioned additives for photography that can be used in the light-sensitive material of the present invention are described in more detail in Research Disclosures (hereinafter abbreviated to as RD) No. 17643 (December 1978), RD No. 18716 (November 1979), and RD No. 307105 (November 1989) and the particular parts are shown below.

| Kind of Additive | | RD 17643 | RD 18716 | RD 307105 |
|---|---|---|---|---|
| 1 | Chemical | p. 23 | p. 648 (right | p. 866 |
| | sensitizers | | column) | |
| 2 | Sensitivity- | — | p. 648 (right | — |
| | enhancing agents | | column) | |
| 3 | Spectral | pp. 23-24 | pp. 648 (right | pp. 866-868 |
| | sensitizers and | | column)-649 | |
| | Supersensitizers | | (right column) | |
| 4 | Brightening | p. 24 | pp. 648 (right | p. 868 |
| | agents | | column) | |
| 5 | Antifogging | pp. 24-26 | p. 649 (right | pp. 868-870 |
| | agents and | | column) | |
| | Stabilizers | | | |
| 6 | Light absorbers, | pp. 25-26 | pp. 649 (right | p. 873 |
| | Filter dyes, and | | column)-650 | |
| | UV Absorbers | | (left column) | |
| 7 | Dye-image | p. 25 | p. 650 (left | p. 872 |
| | stabilizers | | column) | |
| 8 | Hardeners | p. 26 | p. 651 (left | pp. 874-875 |
| | | | column) | |
| 9 | Binders | p. 26 | p. 651 (left | pp. 873-874 |
| | | | column) | |
| 10 | Plasticizers | p. 27 | p. 650 (right | p. 876 |
| | and Lubricants | | column) | |
| 11 | Coating aids | pp. 26-27 | p. 650 (right | pp. 875-876 |
| | and Surfactants | | column) | |
| 12 | Antistatic | p. 27 | p. 650 (right | pp. 876-877 |
| | agents | | column) | |
| 13 | Matting agents | | | pp. 878-879 |

(Organosilver Salt)

The reducible silver salt for use in the present invention is explained below.

The reducible silver salt that can be used in the present invention is relatively stable to light, but it provides a silver ion when heated to a temperature of 80° C. or above, in the presence of a photocatalyst (e.g., latent image of a photosensitive silver halide) exposed to light and of a reducing agent. Such a silver salt is preferably a complex of an organic or inorganic silver salt in which the gross stability constant of the ligand to silver ion, indicative of the complex stability, is within the range of 4.0 to 10.0.

Preferable organosilver salts include a silver salt of an organic compound having a carboxyl group. Preferable examples thereof include a silver salt of an aliphatic carboxylic acid and a silver salt of an aromatic carboxylic acid. Preferable examples of the silver salt of an aliphatic carboxylic acid include silver behenate, silver stearate, silver oleate, silver laurate, silver caprate, silver myristate, silver palmitate, silver maleate, silver fumarate, silver tartrate, silver furoate, silver linoleate, silver butyrate, silver camphorate, and mixtures thereof. A halogen- or hydroxyl-substitutable silver salt can also be effectively used. Preferable examples of the silver salt of an aromatic carboxylic acid or another carboxyl group-containing compound include silver benzoate, silver salts of a substituted benzoic acid (e.g., silver 3,5-dihydroxybenzoate, silver o-methylbenzoate, silver m-methylbenzoate, silver p-methylbenzoate, silver 2,4-dichlorobenzoate, silver acetamidobenzoate, and silver p-phenylbenzoate), silver gallate, silver tannate, silver phthalate, silver terephthalate, silver salicylate, silver phenylacetate, silver pyromellitate, a silver salt of 3-carboxymethyl-4-methyl-4-thiazoline-2-thione, silver salts such as those described in U.S. Pat. No. 3,785,830; and silver salts of an aliphatic carboxylic acid having a thioether group, as described in U.S. Pat. No. 3,330,663.

Also use can be preferably made of a silver salt of a mercapto- or thione-substituted compound having a heterocyclic nucleus, which has 5 or 6 ring atoms such that at least one thereof is nitrogen and other ring atoms include carbon and 2 or less hetero atoms selected from oxygen, sulfur, and nitrogen. Typical preferable examples of the heterocyclic nuclei include triazole, tetrazole, oxazole, thiazole, thiazoline, thiadiazole, imidazoline, imidazole, diazole, pyridine, and triazine. Preferred examples of these heterocyclic compounds include silver salt of 3-mercapto-4-phenyl-1,2,4-triazole, silver salt of 2-mercaptobenzimidazole, silver salt of 2-mercapto-5-aminothiadiazole, silver salt of 2-(2-ethyl-glycolamido)benzothiazole, silver salt of 5-carboxyl-1-methyl-2-phenyl-4-thiopyridine, silver salt of mercaptotriazine, silver salt of 2-mercaptobenzoxazole, silver salt of 1-mercapto-5-alkyl-substituted tetrazole; silver salt of 1-mercapto-5-phenyltetrazole, as described in JP-A-1-100177; silver salts described in U.S. Pat. No. 4,123,274; silver salts of 1,2,4-mercaptothiazole derivatives such as silver salt of 3-amino-5-benzylthio-1,2,4-triazole; silver salts of a thione compound such as silver salt of 3-(2-carboxyethyl)-4-methyl-4-thiazoline-2-thione, as described in U.S. Pat. No. 3,201,678; and other compounds. Further, examples of the useful silver salt of a mercapto- or thione-substituted compound having no heterocyclic nucleus include silver salts of thioglycolic acid such as silver salt of S-alkylthioglycolic acid (said alkyl group contains 12 to 22 carbon atoms); silver salts of dithiocarboxylic acid such as silver salt of dithioacetic acid, and silver salts of thioamides.

Furthermore, silver salts of imino group-containing compounds can be used. Preferable examples of these compounds include silver salts of benzothiazole and derivatives thereof; silver salts of benzotriazoles such as silver salt of methylbenzotriazole; silver salts of halogen-substituted benzotriazoles such as silver salt of 5-chlorobenzotriazole; silver salt of 1,2,4-triazole; silver salts of 1H-tetrazole, as described in U.S. Pat. No. 4,220,709; silver salts of imidazole and silver salts of imidazole derivatives; silver salts of 3-amino-1,2,4-triazoles, as described in JP-A-53-116144, silver salts of substituted or unsubstituted benzotriazoles, and silver salts of benzotriazoles, as described in U.S. Pat. No. 4,500,626, columns 52-53. Further, silver acetylide described in U.S. Pat. No. 4,775,613 is also useful.

Organosilver salts may be used in combinations of two or more thereof. The above-mentioned organosilver salt may be used in an amount of generally 0.01 to 10 moles, preferably 0.01 to 1 mole, per mole of photosensitive silver halide. The total coating amounts of the photosensitive silver halide (emulsion) and the organosilver salt are generally 0.1 to 20 g/m², preferably 1 to 10 g/m², in terms of the amount of silver. The silver-providing substance may constitute preferably about 5 to 70% by mass of the image-forming layer.

The organosilver salt that is preferably used in the present invention is prepared by carrying out a reaction between a solution or suspension of the above-mentioned organic compound or an alkali metal salt thereof (e.g., Na-salt, K-salt, Li-salt, or the like) and silver nitrate, in a tightly closed means designed to mix liquids. As a preparation method for these organosilver salts, those described in JP-A-1-100177 can be employed. Specifically, the methods, which are described in Japanese Patent Application Nos. 11-203413 and 11-104187, paragraphs 0019-0021, can be used.

A method, in which a solution of the organic compound and a solution of silver nitrate are added simultaneously, into a solution of a dispersant, may also be employed.

In the present invention, when the organosilver salt is prepared, a water-soluble dispersant may be added to the aqueous solution of silver nitrate and the solution of the organic compound or an alkali metal salt thereof, or to the reaction solution. Specific examples of the kinds and amounts of the dispersant to be used are described in Japanese Patent Application No. 11-115457, paragraph 0052.

The method for forming the silver salt of an organic compound that can be preferably used in the present invention, is the method in which the silver salt of the organic compound is formed while controlling pH, as described in JP-A-1-100177.

The organosilver salt for use in the present invention is preferably a desalted one. The desalting method is not particularly limited and any known method can be employed. As the desalting method, a known filtration method, such as centrifugal filtration, suction filtration, ultrafiltration, flock-forming water-washing by a flocculation method, can be preferably employed. As to the ultrafiltration method, the method described in Japanese Patent Application No. 11-115457 can be used.

In the present invention, in order to obtain a dispersion of solid organosilver salt particles free of flocculation and small in particle size, it is preferable to employ a dispersing method wherein an aqueous dispersion, which contains an organosilver salt as an image-forming medium and does not substantially contain any light-sensitive silver salt, is transformed into a high-speed stream and thereafter the pressure is dropped. As to such dispersing methods, the methods described in Japanese Patent Application No. 11-104187, paragraphs 0027-0038, can be employed.

The shape and size of the organosilver salt that can be used in the present invention are not particularly limited, and a dispersion of solid fine-particles having an average particle size of 0.001 to 5.0 μm is preferable. A more preferable average particle size is 0.005 to 1.0 μm.

The particle size distribution of the dispersion of solid organosilver salt fine-particles for use in the present invention is preferably monodispersed. More specifically, the percentage of the value (variation coefficient), which is obtained by dividing the standard deviation of the volume-weighted average diameter by the volume-weighted average diameter, is preferably 80% or less, more preferably 50% or less, and further preferably 30% or less.

The dispersion of solid organosilver salt fine-particles for use in the present invention, at least comprises an organosilver salt and water. Although the proportion between the organosilver salt and water is not particularly limited, it is preferable that the proportion of the organosilver salt accounts for 5 to 50% by mass of the total. In particular, the range of 10 to 30% by mass is preferable. Although the use of the above-mentioned dispersant is preferable, it is preferable to use the dispersant in a minimum amount within a range suitable for minimizing the particle size. The amount of the dispersant is preferably in the range of 0.5 to 30% by mass, in particular in the range of 1 to 15% by mass, relative to the organosilver salt.

In the present invention, a metal ion, which is selected from Ca, Mg, and Zn, may be added to the non-photosensitive organosilver salt.

The photosensitive silver halide and/or reducible silver salt in the present invention, can be further protected by a known anti-fogging agent, stabilizer, and a precursor thereof, against the formation of additional fogging, so that the decrease in sensitivity during storage can be more efficiently prevented to stabilize the resultant photographic material. Preferable examples of the anti-fogging agent, stabilizer, and stabilizer precursor that can be used singly or in combination, include thiazonium salts described in U.S. Pat. Nos. 2,131,038 and 2,694,716, azaindenes described in U.S. Pat. Nos. 2,886,437 and 2,444,605, mercury salts described in U.S. Pat. No. 2,728,663, urasoles described in U.S. Pat. No. 3,287,135, sulfocatechols described in U.S. Pat. No. 3,235,652; oximes, nitrons, and nitroindazoles described in U.K. Patent No. 623,448; salts of multivalent metals, as described in U.S. Pat. No. 2,839,405; thiuronium salts described in U.S. Pat. No. 3,220,839; salts of palladium, platinum, and gold, as described in U.S. Pat. Nos. 2,566,263 and 2,597,915; halogen-substituted organic compounds described in U.S. Pat. Nos. 4,108,665 and 4,442,202, triazines described in U.S. Pat. Nos. 4,128,557, 4,137,079, 4,138,365, and 4,459,350, phosphorus compounds described in U.S. Pat. No. 4,411,985, and organohalogeno compounds as disclosed in JP-A-50-119624, JP-A-54-58022, JP-A-56-70543, JP-A-56-99335, JP-A-61-129642, JP-A-62-129845, JP-A-6-208191, JP-A-7-5621, and JP-A-8-15809, and U.S. Pat. Nos. 5,340,712, 5,369,000, and 5,464,737.

(Color-developing Agent)

The heat-developable light-sensitive material of the present invention has a color-developing agent, on the same side as that of a photosensitive silver halide and a reducible silver salt, on the support.

Examples of the color-developing agent include p-phenylenediamines and p-aminophenols. More preferable examples include sulfonamidophenols described in JP-A-8-110608, JP-A-8-122994, JP-A-9-15806, JP-A-9-146248, and the like; sulfonylhydrazines described in European Patent No. 545,491A, and JP-A-8-166664 and JP-A-8-227131; carbamoylhydrazines described in JP-A-8-286340; sulfonylhydrazones described in JP-A-8-202002, JP-A-10-186564, and JP-A-10-239793; carbamoylhydrazones described in JP-A-8-234390; sulfamic acids described in JP-B-63-36487; sulfohydrazones described in JP-B-4-20177; 4-sulfonamidopyrazolones described in JP-B-5-48901; p-hydroxyphenylsulfamic acids described in JP-B-4-69776; sulfamic acids which have an alkoxy group on a benzene ring and are described in JP-A-62-227141; hydrophobic salts which are formed from a color-developing agent having an amino group and an organic acid and are described in JP-A-3-15052; hydrazones described in JP-B-2-15885; ureidoanilines described in JP-A-59-111148; sulfamoylhydrazones described in U.S. Pat. No. 4,430,420; derivatives of an aromatic primary amine developing agent having a sulfonylaminocarbonyl group or an acylaminocarbonyl group, as described in JP-B-3-74817; compounds which release an aromatic primary amine developing agent by a reverse Michael reaction, as described in JP-A-62-131253; derivatives of an aromatic primary amine developing agent having a fluorine-substituted acyl group, as described in JP-B-5-33781; derivatives of an aromatic primary amine developing agent having an alkoxycarbonyl group, as described in JP-B-5-33782; derivatives of an aromatic primary amine developing agent which are of an oxalic acid amide type, as described in JP-A-63-8645; and derivatives of an aromatic primary amine developing agent which are of a Schiff base type, as described in JP-A-63-123043. Among these color-developing agents, sulfonamidophenols described in JP-A-8-110608, JP-A-8-122994, JP-A-8-146578, JP-A-9-15808, JP-A-9-146248, and the like; carbamoylhydrazines described in JP-A-8-286340, and derivatives of an aromatic primary amine developing agent, as described in JP-B-3-74817 and JP-A-62-131253 are preferable.

In the present invention, although the amount of the developing agent to be added may vary over a wide range, the amount is preferably 0.01 to 100 times, more preferably 0.1 to 10 times, relative to the amount of the coupler compound.

When added to the coating solution, the developing agent for use in the present invention may be in any state which includes a solution, a powder, a dispersion of solid fine-particles, an emulsion, and a dispersion using a protective oil. Examples of the grinding means for obtaining the dispersion of solid fine-particles include a ball mill, a vibration ball mill, a sand grinder mill, a colloid mill, a jet mill, and a roller mill. Besides, at the time of manufacture of the dispersion of solid fine-particles, a dispersant such as a surfactant, a water-soluble polymer, and an oligomer may be used.

(Coupler)

The heat-developable light-sensitive material of the present invention has a coupler compound, on the same side as that of a photosensitive silver halide and a reducible silver salt, on the support. The coupler compound for use in the present invention is a compound which is called “color coupler” and is known in photographic industries. A 2-equivalent or 4-equivalent coupler can be used. Examples of the coupler for photography that can be used include the functional couplers explained by N. Furutate, in “Organic Compounds for Conventional Color Photography”, Journal of The Society of Synthetic Organic Chemistry, Japan, Vol. 41, p. 439, 1983) and the couplers whose details are described in Research Disclosure 37038 (February, 1995), pages 80-85 and pages 87-89.

To be more specific, examples of the coupler for forming a yellow dye image include pivaloylacetamide-type couplers, benzoylacetamide-type couplers, malonic diester-type couplers, malonic diamide-type couplers, dibenzoylmethane-type couplers, benzothiazolylacetamide-type couplers, malonic ester monoamide-type couplers, benzoxazolylacetamide-type couplers, benzimidazolylacetamide-type couplers, benzothiazolylacetamide-type couplers, cycloalkylcarbonylacetamide-type couplers, indoline-2-ylacetamide-type couplers, quinazoline-4-one-2-ylacetamide-type couplers described in U.S. Pat. No. 5,021,332, benzo-1,2,4-thiadiazine-1,1-dioxide-3-ylacetamide-type couplers described in U.S. Pat. No. 5,021,330, couplers described in European Patent No. 421221A, couplers described in U.S. Pat. No. 5,455,149, couplers described in European Patent No. 0622673A, and 3-indoloylacetamide-type couplers described in European Patent Nos. 0953871A, 0953872A, and 0953873A.

Examples of the coupler for forming a magenta dye image include 5-pyrazolone-type couplers, 1H-pyrazolo[1,5-a]benzimidazole-type couplers, 1H-pyrazolo[5,1-c][1,2,4]triazole-type couplers, 1H-pyrazolo[1,5-b][1,2,4]triazole-type couplers, 1H-imidazo[1,2-b]pyrazole-type couplers, cyanoacetophenone-type couplers, active propane-type couplers described in WO93/01523, enamine-type couplers described in WO93/07534, 1H-imidazo[1,2-b][1,2,4]triazole-type couplers, and couplers described in U.S. Pat. No. 4,871,652.

Examples of the coupler for forming a cyan dye image include phenol-type couplers, naphthol-type couplers, 2,5-diphenylimidazole-type couplers described in European Patent No. 0249453A, 1H-pyrrolo[1,2-b][1,2,4]triazole-type couplers, 1H-pyrrolo[2,1-c][1,2,4]triazole-type couplers, pyrrole-type couples described in JP-A-4-188137 and JP-A-4-190347, 3-hydroxypyridine-type couples described in JP-A-1-315736, pyrrolopyrazole-type couplers described in U.S. Pat. No. 5,164,289, pyrroloimidazole-type couplers described in JP-A-4-174429, pyrazolopyrimidine-type couplers described in U.S. Pat. No. 4,950,585, pyrrolotriazine-type couplers described in JP-A-4-204730, couplers described in U.S. Pat. No. 4,746,602, couplers described in U.S. Pat. No. 5,104,783, couplers described in U.S. Pat. No. 5,162,196, and couplers described in European Patent No. 0556700.

The coupler compound for use in the present invention can be easily synthesized by any method known in photographic industries, as described in the aforesaid patent publications and the like relating to couplers.

The coupler compound for use in the present invention can be used after being dissolved in water or a suitable organic solvent such as alcohol (e.g., methanol, ethanol, propanol, or fluorinated alcohol), ketone (e.g., acetone or methyl ethyl ketone), dimethylformamide, dimethyl sulfoxide, or methyl cellosolve.

A hydrophobic additive such as the coupler, color-developing agent, or the like can be introduced into a layer of the light-sensitive material by a known method, for example, the method described in U.S. Pat. No. 2,322,027. In this case, a high boiling point organic solvent, which is described in U.S. Pat. Nos. 4,555,470, 4,536,466, 4,536,467, 4,587,206, 4,555,476, and 4,599,296, JP-B-3-62256, and the like, may be used singly or, if necessary, in combination with a low boiling point organic solvent whose boiling point is 50 to 160° C. Further, two or more kinds of these dye-providing couplers, high boiling point organic solvents, and the like may be used together.

The amount of the high boiling point organic solvent is generally 10 g or less, preferably 5 g or less, and more preferably 1 g or less, per gram of the hydrophobic additive to be used. The amount of the high boiling point organic solvent is generally 1 ml or less, preferably 0.5 ml or less, and more preferably 0.3 ml or less, per gram of the binder.

Furthermore, it is also possible to employ a method which is a dispersing method utilizing a polymer and is described in JP-B-51-39853 and JP-A-51-59943 and a method which comprises making a dispersion of fine particles and thereafter adding it and is described in JP-A-62-30242.

In the case of a compound substantially insoluble in water, the compound may be dispersed as fine particles and contained in a binder, in place of the methods described above.

When a hydrophobic compound is dispersed in a hydrophilic colloid, various surfactants can be used. Examples of the surfactants that can be used include those described in JP-A-59-157636, pages (37)-(38), and those described in the above Research Disclosures. It is also possible to use phosphoric ester-type surfactants described in JP-A-7-56267, JP-A-7-228589, and West German Patent Application Laid-Open (OLS) No. 1,932,299A.

It is also possible to use a coupler compound as an aqueous dispersion thereof obtained by dispersing a powder of the coupler compound according to a well-known solid-dispersing method by use of a media disperser, such as ball mill, colloid mill, or sand grinder mill, or by a homogenizer, such as Manton-Gaulin, microfluidizer, or ultrasonic homogenizer.

The coupler compound for use in the present invention may be added to any layer only if the layer to which the coupler compound is added is on the same side of the support as that of a layer containing a photosensitive silver halide and a layer containing a reducible silver salt. Preferably the coupler compound is added to the layer containing a photosensitive silver halide or to a layer adjacent thereto.

The amount to be added of the coupler compound for use in the present invention is preferably 0.2 to 200 mmol, more preferably 0.3 to 100 mmol, and further preferably 0.5 to 30 mmol, per mole of silver (e.g. silver of the silver halide in the same light-sensitive layer). The coupler compounds may be used singly or in a combination of two or more.

In the case where the light-sensitive material of the present invention is used as a light-sensitive material for shooting, the amount to be added of the coupler that can be used in the present invention is generally 0.2 to 10 mmol, preferably 0.5 to 1 mmol, per mol of silver (e.g. silver of the silver halide in the same light-sensitive layer).

Further, the following functional couplers can also be used in the present invention. Preferable examples of couplers, which form a color dye having a suitable diffusive property, include those described in U.S. Pat. No. 4,366,237, GB Patent No. 2,125,570, European Patent No. 96,873B, and DE Patent No. 3,234,533.

Examples of the coupler, which is used for compensating unnecessary absorption of a resultant color dye, include a yellow-colored cyan coupler described in European Patent No. 456,257A1, a yellow-colored magenta coupler described in European Patent No. 456,257A1, a magenta-colored cyan coupler described in U.S. Pat. No. 4,833,069, and a colorless masking coupler represented by formula (2) in U.S. Pat. No. 4,837,136 or formula (A) in claim 1 of WO92/11575 (particularly the exemplified compounds on pages 36 to 45).

Examples of the compound (including a coupler), which reacts with an oxidized product of a developing agent, to release a photographically useful compound's residue, include the followings:

Development inhibitor-releasing compounds: compounds represented by any one of Formulae (I) to (IV) described on page 11 in European Patent No. 378,236A1, compounds represented by Formula (I) described on page 7 in European Patent No. 436,938A2, compounds represented by Formula (1) in European Patent No. 568,037A, and compounds represented by Formula (I), (II), or (III) described on pages 5 to 6 in European Patent No. 440,195A2.

Bleaching accelerator-releasing compounds: compounds represented by Formula (I) or (II) described on page 5 in European Patent No. 310,125A2 and compounds represented by Formula (I) described in claim 1 of JP-A-6-59411.

Ligand-releasing compounds: compounds represented by LIG-X described in claim 1 of U.S. Pat. No. 4,555,478.

Leuco dye-releasing compounds: compounds 1 to 6 in U.S. Pat. No. 4,749,641, columns 3 to 8.

Fluorescent dye-releasing compounds: compounds represented by COUP-DYE described in claim 1 of U.S. Pat. No. 4,774,181.

Compounds, which release a development accelerator or a fogging agent: compounds represented by Formula (1), (2) or (3) in U.S. Pat. No. 4,656,123, column 3, and compounds ExZK-2 described on page 75, lines 36 to 38, in European Patent No. 450,637A2.

Compounds which release a group capable of becoming a dye only after being split-off: compounds represented by Formula (I) described in claim 1 of U.S. Pat. No. 4,857,447, compounds represented by Formula (1) in JP-A-5-307248, compounds represented by Formula (I), (II) or (III) on pages 5 to 6 in European Patent No. 440,195A2, compounds-ligand releasing compounds represented by Formula (I) described in claim 1 in JP-A-6-59411, and compounds represented by LIG-X described in claim 1 of U.S. Pat. No. 4,555,478.

Any of these functional couplers are used in an amount of preferably 0.05 to 10 times, and more preferably 0.1 to 5 times, the molar amount of the above-mentioned coupler contributing to the color formation.

(Base Precursor)

The light-sensitive material of the present invention may contain a nucleophilic agent (nucleophile) or a nucleophile precursor, in order to accelerate reactions, such as the coupling reaction between an oxidized product of the color-developing agent and the coupler, the releasing (elimination) reaction of a block group from a dye precursor formed by coupling, and the like. It is preferable to use the nucleophile precursor, in view of raw stock storability of the light-sensitive material.

Although various nucleophile precursors are known, it is advantageous to use a precursor that forms (or releases) a base by heating, because the use of such a precursor releases a nucleophile at the time of heat development. A thermal decomposition-type (decarboxylation-type) base precursor, which is composed of a salt of a carboxylic acid and a base, is representative, as the base precursor that forms a base by heating. When the decarboxylation-type base precursor is heated, the carboxyl group of the carboxylic acid undergoes a decarboxylation reaction, and a base is released. Sulfonylacetic acid or propiolic acid, which easily causes a decarboxylation reaction, can be used as the carboxylic acid. It is preferable that the sulfonylacetic acid or propiolic acid has a group (i.e., an aryl group or unsaturated heterocyclic group), which has aromaticity capable of accelerating the decarboxylation, as a substitutent. The base precursors of a salt of sulfonylacetic acid are described in JP-A-59-168441. The base precursors of a salt of propiolic acid are described in JP-A-59-180537. The base-constituting component of the decarboxylation-type base precursor is preferably an organic base, and more preferably amidine, guanidine, or a derivative thereof. The organic base is preferably a diacidic base, triacidic base, or tetraacidic base, more preferably a diacidic base, and most preferably a diacidic base of an amidine derivative or guanidine derivative.

The precursors of the diacidic base, triacidic base, or tetraacidic base of an amidine derivative are described in JP-B-7-59545. The precursors of the diacidic base, triacidic base, or tetraacidic base of a guanidine derivative are described in JP-B-8-10321. The diacidic base of an amidine derivative or guanidine derivative comprises: (A) two amidine or guanidine moieties; (B) a substituent of the amidine or guanidine moiety; and (C) a divalent linking group linking the two amidine or guanidine moieties. Examples of the substituent (B) include an alkyl group (including a cycloalkyl group), an alkenyl group, an alkynyl group, an aralkyl group, and a heterocyclic residue. Two or more of the substituents may join together to form a nitrogen-containing heterocycle. The linking group (C) is preferably an alkylene group or a phenylene group. Examples of the diacidic base precursor of an amidine or guanidine derivative that is preferably used in the present invention, are BP-1 to BP-41 described in JP-A-11-231457, pages 19-26. Among these precursors, salts of p-(phenylsulfonyl)-phenylsulfonylacetic acid, such as BP-9, BP-32, BP-35, BP-40, and BP-41, are particularly preferable.

The amount (in moles) of the base precursor to be used is preferably 0.1 to 10 times, more preferably 0.3 to 3 times, the amount (in moles) of the color-developing agent to be used. It is preferable that the base precursor is dispersed in the state of solid fine-particles, by means of a a ball mill, sand grinder mill, and the like.

(Thermal Solvent)

In the present invention, a thermal solvent can be preferably incorporated. Herein, the term “thermal solvent” means an organic material, which is a solid at ambient temperature, but exhibits a mixed melting point together with another component at or below a thermal processing temperature to be employed, and liquefies at the time of heat development, so as to accelerate the heat development or the thermal transfer of a dye. Useful as the thermal solvent are a compound capable of becoming a solvent for the developing agent, a compound having a high dielectric constant, to accelerate the physical development of a silver salt, a compound compatible with a binder and capable of swelling the binder, and the like.

Examples of the thermal solvent that can be used in the present invention include the compounds described, for example, in U.S. Pat. Nos. 3,347,675, 3,667,959, 3,438,776, and 3,666,477, Research Disclosure No. 17,643, JP-A-51-19525, JP-A-53-24829, JP-A-53-60223, JP-A-58-118640, JP-A-58-198038, JP-A-59-229556, JP-A-59-68730, JP-A-59-84236, JP-A-60-191251, JP-A-60-232547, JP-A-60-14241, JP-A-61-52643, JP-A-62-78554, JP-A-62-42153, JP-A-62-44737, JP-A-63-53548, JP-A-63-161446, JP-A-1-224751, JP-A-2-863, JP-A-2-120739, JP-A-2-123354, and JP-A-4-289856. More specifically, preferred examples of the thermal solvent that can be used in the present invention include urea derivatives (e.g., urea, dimethylurea, and phenylurea), amide derivatives (e.g., acetamide, stearylamide, p-toluamide, and p-propanoyloxyethoxybenzamide), sulfonamide derivatives (e.g., p-toluenesulfonamide), and polyhydric alcohols (e.g., 1,6-hexanediol, pentaerythritol, D-sorbitol, and polyethylene glycol).

(Binder)

In the heat-developable light-sensitive material of the present invention, a binder is generally used in light-sensitive layers, and in non-light sensitive layers such as a colored layer, a protective layer, and an intermediate layer. The binder may be arbitrarily selected from well-known natural or synthetic resins, such as gelatin, polyvinyl acetal, polyvinyl chloride, polyvinyl acetate, cellulose acetate, polyolefin, polyester, polystyrene, polyacrylonitrile, polycarbonate, and an SBR latex purified by ultrafiltration (UF). Needless to say, examples of the binder also include a copolymer and a terpolymer. If necessary, combinations of two or more of these polymers can be employed. These polymers are used in an amount sufficient for holding therein the components. That is, these polymers are used in an amount falling in the range effective in functioning as a binder. Persons skilled in the art can determine the effective range properly.

The binder of the light-sensitive material is preferably a hydrophilic one. Examples of the hydrophilic binder include the binders described in the above-mentioned Research Disclosures and in JP-A-64-13546, pages 71-75. Specifically, a transparent or semitransparent hydrophilic binder is preferable, and examples include natural compounds, such as proteins including gelatin, gelatin derivatives, and the like, or polysaccharides including cellulose derivatives, starches, gum-arabic, dextrans, pullulan, and the like; and synthetic polymer compounds such as polyvinyl alcohols, modified polyvinyl alcohols, polyvinyl pyrrolidones, and polyacrylamides. Among these binders, gelatin and combinations of gelatin with another water-soluble binder, such as polyvinyl alcohol, modified polyvinyl alcohol, polyacrylamide, or cellulose derivative, are preferable. The coating amount of the binder is generally 1 to 25 g/m², preferably 3 to 20 g/m², and more preferably 5 to 15 g/m². Gelatin is used in proportions of generally 50 to 100% by mass, preferably 70 to 100% by mass, in the combination.

(Layer Constitution)

Generally, a light-sensitive material comprises three or more light-sensitive layers each having a different light-sensitivity, wherein each light-sensitive layer contains at least one silver halide emulsion layer. As a typical example, each set of the silver halide emulsion layer is composed of a plurality of silver halide emulsion layers which have substantially the same color sensitivity but have different levels of sensitivity. In this case, it is preferable to use silver halide grains such that a silver halide grain having a larger projected grain diameter has a larger value of so-called aspect ratio, i.e., a value obtained by dividing the projected grain diameter by the grain thickness. The light-sensitive layer is a unit light-sensitive layer having sensitivity to any one of blue light, green light, and red light. In the case of a multilayer silver halide color photographic light-sensitive material, a generally adopted order of the unit light-sensitive layers from the support side is a red-sensitive layer, a green-sensitive layer, and a blue-sensitive layer. However, depending on purposes, this order of layers may be reversed, or an order, in which light-sensitive layers sensitive to the same color sandwich a light-sensitive layer sensitive to a different color, is also possible. The total film thickness of the light-sensitive layer is generally 2 to 40 μm and preferably 5 to 25 μm.

Each of the silver halide emulsion layers constituting unit photosensitive layers respectively can preferably take a two-layer constitution composed of a high-sensitive emulsion layer and a low-sensitive emulsion layer, as described in DE Patent No. 1 121 470 or GB Patent No. 923 045. Generally, they are preferably arranged such that the sensitivities are decreased toward the support. As described, for example, in JP-A-57-112751, JP-A-62-200350, JP-A-62-206541, and JP-A-62-206543, a low-sensitive emulsion layer may be placed away from the support, and a high-sensitive emulsion layer may be placed nearer to the support.

A specific example of the order includes an order of a low-sensitive blue-sensitive layer (BL)/high-sensitive blue-sensitive layer (BH)/high-sensitive green-sensitive layer (GH)/low-sensitive green-sensitive layer (GL)/high-sensitive red-sensitive layer (RH)/low-sensitive red-sensitive layer (RL), or an order of BH/BL/GL/GH/RH/RL, or an order of BH/BL/GH/GL/RL/RH, stated from the side most away from the support.

As described in JP-B-55-34932, an order of a blue-sensitive layer/GH/RH/GL/RL stated from the side most away from the support is also possible. Further as described in JP-A-56-25738 and JP-A-62-63936, an order of a blue-sensitive layer/GL/RL/GH/RH stated from the side most away from the support is also possible.

Further as described in JP-B-49-15495, an arrangement is possible wherein the upper layer is a silver halide emulsion layer highest in sensitivity, the intermediate layer is a silver halide emulsion layer lower in sensitivity than that of the upper layer, the lower layer is a silver halide emulsion layer further lower in sensitivity than that of the intermediate layer, so that the three layers different in sensitivity may be arranged with the sensitivities successively lowered toward the support. Even in such a constitution comprising three layers different in sensitivity, an order of a medium-sensitive emulsion layer/high-sensitive emulsion layer/low-sensitive emulsion layer stated from the side away from the support may be taken in layers identical in color sensitivity, as described in JP-A-59-202464.

Further, for example, an order of a high-sensitive emulsion layer/low-sensitive emulsion layer/medium-sensitive emulsion layer, or an order of a low-sensitive emulsion layer/medium-sensitive emulsion layer/high-sensitive emulsion layer can be taken. In the case of four layers or more layers, the arrangement can be varied as above.

In order to improve color reproduction, as described in U.S. Pat. Nos. 4,663,271, 4,705,744, and 4,704,436, and JP-A-62-160448 and JP-A-63-89850, it is preferable to form a donor layer (CL), which has a spectral sensitivity distribution different from those of a principal (main) light-sensitive layer, such as B, G and R, and which has an inter-layer effect, in a position adjacent or in close proximity to the principal light-sensitive layer.

In the present invention, although a silver halide, a dye-providing coupler, and a color-developing agent (or its precursor) may be contained in the same layer, these substances may be separately contained in different layers if these substances are present in a reactive state.

Although the relationship between the spectral sensitivity and the hue resulting from the coupler is arbitrary in each layer, generally a cyan coupler is used in the red-sensitive layer, a magenta coupler is used in the green-sensitive layer, and a yellow coupler is used in the blue-sensitive layer.

(Decolorizable Dye)

In the present invention, a yellow filter layer, a magenta filer layer, and an antihalation layer can be used, as a colored layer, in which a dye capable of being decolorized upon processing is used. Accordingly, if the order of light-sensitive layers from the nearest side of the support is, for example, a red-sensitive layer, a green-sensitive layer and a blue-sensitive layer, it is possible to provide a yellow filter layer between the blue-sensitive layer and the green-sensitive layer, to provide a magenta filter layer between the green-sensitive layer and the red-sensitive layer, and to provide a cyan-colored filter layer (antihalation layer) between the red-sensitive layer and the support. These colored layers may be in contact with an emulsion layer either directly or via an interlayer such as gelatin. The amount of the dye to be used is such that the transmission densities of the layers are generally 0.03 to 3.0, preferably 0.1 to 1.0, for blue light, green light and red light, respectively. More specifically, the amount is preferably 0.005 to 2.0 mmol/m and more preferably 0.05 to 1.0 mmol/m although the amount depends on E and molecular weights of the dye to be used.

That “the dye, which is present in a yellow filter layer, an antihalation layer, or the like, is decolorized or eliminated at the time of development” means that the amount of the dye remaining after the development processing is generally one third or less, preferably one tenth or less, of the amount of the dye present immediately before the coating.

The light-sensitive material of the present invention may contain a mixture of two or more dyes in one colored layer. For example, the antihalation layer described above may contain a mixture of three dyes, i.e., a yellow dye, a magenta dye, and a cyan dye.

Specifically, dyes described in European Patent Application No. 549,489A, and dyes ExF 2 to 6 described in JP-A-7-152129, can be mentioned. A dye in the state in which solid (fine-crystalline) particles of the dye are dispersed, as described in JP-A-8-101487, can also be used.

The dye may also be mordanted with a mordant and a binder. In this case, as the mordant and the dye, those known in the field of photography can be used, and examples include mordants described, for example, in U.S. Pat. No. 4,500,626, columns 58 to 59, and JP-A-61-88256, pages 32 to 41, JP-A-62-244043, and JP-A-62-244036.

Leuco dyes or the like that lose their color can also be used, and specifically, a silver halide light-sensitive material containing a leuco dye that has been color-formed previously with a developer of an organic acid metal salt, is disclosed in JP-A-1-150132. The leuco dye and a color developer complex are decolorized by heat or reacting with an alkai agent.

Known leuco dyes can be used, examples of which are described by Moriga and Yoshida, in “Dyes and Chemicals”, Vol.9, pp.84, Association of Chemical Products, in “New Handbook of Dyes”, pp.242, Maruzen Co., Ltd. (1970), by R. Garner, in “Reports on the Progress of Applied Chemistry”, Vol.56, p.199 (1971), in “Dyes and Chemicals”, Vol.19, pp.230, Association of Chemical Products (1974), in “Color Materials”, Vol.62, pp.288 (1989), and in “Dye Industry”, Vol.32, pp.208, and the like.

Color developers that are preferably used are acid clay-based color developers, phenol/formaldehyde resins, and metal salts of organic acids. Among the metal salts of organic acids, examples of useful ones include metal salts of salicylic acids, metal salts of a phenol/salicylic acid/formaldehyde resin, rhodanates, and metal salts of xanthogenic acid. Zinc is particularly preferable as a metal. Among these color developers, as to oil-soluble zinc salicylates, those described in U.S. Pat. Nos. 3,864,146 and 4,046,941, and JP-B-52-1327 can be used.

It is also possible to use a dye which can be decolorized in the presence of a decolorizer at the time of processing. Examples of the dye that can be used include cyclic ketomethylene compounds described in JP-A-11-207027 and 2000-89414, cyanine dyes described in European Patent No. 911693A1, polymethine dyes described in U.S. Pat. No. 5,324,627, and merocyanine dyes described in JP-A-2000-112058.

It is preferable that these decolorizable dyes are dispersed in the state of a dispersion of fine-crystalline particles described above, and the dispersion is added to the light-sensitive material. Alternatively, these decolorizable dyes may be used in the state of a dispersion prepared by dispersing in a hydrophilic binder the oil droplets which are prepared by dissolving the dye in an oil and/or an oil-soluble polymer. As a method for preparing the dispersion, preferable is an emulsification dispersion method which is described in, for example, U.S. Pat. No. 2,322,027. In this case, an oil having a high boiling point, which is described in U.S. Pat. Nos. 4,555,470, 4,536,466, 4,587,206, 4,555,476 and 4,599,296, JP-B-3-62,256, and the like can be used, if necessary, together with an organic solvent having a low boiling point in the range of 50 to 160° C. Two or more of the oils having a high boiling point can be used together. Besides, an oil-soluble polymer may be used in place of or together with the oil, as described in the specification of PCT International Laying-Open No. WO88/00723. The amount to be used of the oil having a high boiling point and/or the polymer is generally 0.01 to 10 g, preferably 0.1 to 5 g, per gram of the dye to be used.

The above-mentioned dyes are decolorized in the presence of a decolorizer when processed. Examples of the decolorizer include alcohols or phenols, amines or anilines, sulfinic acids or salts thereof, sulfurous acid or salts thereof, thiosulfuric acid or salts thereof, carboxylic acids or salts thereof, hydrazines, guanidines, aminoguanidines, amidines, thiols, cyclic or chain-like active methylene compounds, cyclic or chain-like active methine compounds, and anion species derived from these compounds.

Among these compounds, hydroxylamines, sulfinic acids, sulfurous acid, guanidines, aminoguanidines, heterocyclic thiols, cyclic or chain-like active methylene compounds, and cyclic or chain-like active methine compounds are preferably used. Guanidines and aminoguanidines are particularly preferable. The base precursors described above can also be preferably used.

In this case, the concentration of the dye after the decolorization is generally one third or less and preferably one fifth or less of the original concentration. The molar amount of the decolorizer to be used is in the range of generally 0.1 to 200 times and preferably 0.5 to 100 times that of the dye.

Also, a dye decolorizable in a reversible manner can be preferably used in the present invention. This dye has a color at a temperature below a decolorization-starting temperature (T), but at least part of the dye is decolorized at the temperature T or above, and the change can be reversed. In the present invention, use can be made of a method, using the dye reversibly decolorizable, wherein readout is carried out at the decolorization temperature (T ° C.) or above so that the deterioration of S/N due to the concentration of the dye at the time of readout can be prevented. The dye having such a reversible property can be prepared by a combination of a leuco dye described in JP-B-51-44706, a phenolic color developer, and a higher alcohol.

(Coating, Forming)

The light-sensitive emulsion layers and backing layers that can be provided in the present invention can be formed by a coating method. Examples of the coating method include generally well-known coating methods, such as a dip coating method, air knife coating method, curtain coating method, roller coating method, wire bar coating method, gravure coating method, and extrusion-coating method using a hopper (as disclosed in U.S. Pat. No. 2,681,294). Further, in view of the production efficiency, it is preferable to coat multilayers simultaneously by a method as described, for example, in the specifications of U.S. Pat. Nos. 2,761,791, 3,508,947, 2,941,898, and 3,526,528, and by Yuji Harasaki, in “Coating Technology (Coating Kogaku)”, p. 253 (published by Asakura Shoten, 1973).

The light-sensitive material of the present invention can be made into any of existing sizes. That is, examples of the sizes include 12EX, 24EX, and 36EX for 135 size, 15EX, 25EX, and 40EX for APS size, 6EX and 12EX for 120 size, 24EX for 220 size, 4×5 inch size, 8×10 inch size, and the like.

Next, a film magazine (patrone), in which a light-sensitive material in a state of a strip such as a 135 or APS size can be loaded, is described below.

The main material of the magazine for use in the present invention may be a metal or synthetic plastic.

Further, the magazine may be one in which a spool is rotated to deliver a film. Also the structure may be such that the forward end of film is housed in the magazine body, and by rotating a spool shaft in the delivering direction, the forward end of the film is delivered out from a port of the magazine. These magazines are disclosed in U.S. Pat. Nos. 4,834,306, and 5,226,613.

Preferable plastic materials are polystyrenes, polyethylenes, polypropylenes, polyphenyl ethers, and the like. Further, the magazine that can be used in the present invention may contain various antistatic agents, and preferably, for example, carbon black, metal oxide particles; nonionic, anionic, cationic, and betaine-series surface-active agents, or polymers can be used. These antistatic magazines are described in JP-A-1-312537 and JP-A-1-312538. In particular, the resistance of the magazine at 25° C. and 25% RH is preferably 10¹²Ω or less. Generally, plastic magazines are made of plastics with which carbon black or a pigment has been kneaded, to make the magazines screen light. The size of the magazine may be size 135, which is currently used, and, to make cameras small, it is effective to change the diameter of the 25-mm cartridge of the current size 135, to 22 mm or less. Preferably the volume of a case of the magazine is 30 cm³ or less, and more preferably 25 cm³ or less. The weight of the plastic to be used for the magazine or the magazine case is preferably 5 to 15 g.

In the photographic film according to the present invention, the raw film and the photographic film after being processed for development may be housed in the same new magazine or in different magazines.

The color photographic light-sensitive material of the present invention can be advantageously used also as a negative film for advanced photo system (hereinafter referred to as APS system). Examples of the film include a film, manufactured by making the light-sensitive material film into APS system format and housing it into a cartridge for exclusive use, such as NEXIA series, i.e., NEXIA-F, NEXIA-A2000, NEXIA-H400, and NEXIA ZOOM MASTER 800 (ISO 100/200/400/800 in that order) (trade names) manufactured by Fuji Photo Film Co., Ltd. (hereinafter referred to as Fuji Film). These cartridge films for APS system are used after being loaded into cameras for APS system, such as EPION series (trade names) manufactured by Fuji Film.

The color photographic light-sensitive material of the present invention is also preferable for use in a film unit with a lens, which is represented by Fuji Color UTSURUNDESU Super Slim (trade name) manufactured by Fuji Film, and which is described, for example, in JP-B-2-32615 and JU-B-3-39784 (“JU-B” means examined Japanese utility model publication).

A film unit with a lens is a unit body comprising a plastic case, which is manufactured, for example, by an injection molding process and is provided with a photographing lens and a shutter, wherein, in the manufacturing process, a color or monochrome photographic light-sensitive material before exposure is loaded into the plastic case in a light-tight manner.

In any package unit, the humidity of the atmosphere in contact with the photographic light-sensitive material of the present invention inside the package is preferably 30 to 80% RH, more preferably 40 to 60% RH, at 25° C.

Control of the humidity of the atmosphere in contact with the light-sensitive material of the present invention inside the package can be performed by control of drying condition following the coating of the light-sensitive material, control of temperature and humidity when being wound into a roll after drying, control of temperature and humidity while the roll is stored, control of temperature and humidity when being processed, and the like. Control of the humidity may be carried out at any of the above-mentioned steps.

(Heat-development Processing)

Examples of the heating method in the development step include a method wherein the photographic material is brought in contact with a heated block or plate; a method wherein the photographic material is brought in contact with a hot plate, a hot presser, a hot roller, a hot drum, a halogen lamp heater, an infrared lamp heater, or a far-infrared lamp heater; and a method wherein the photographic material is passed through a high-temperature atmosphere.

As a heat source, a heater such as a heated liquid, a dielectric substance, a microwave, or the like can be used, besides a usual electric heater or lamp heater.

A preferred mode of the thermally-developing apparatus to be used is an apparatus of a type based on the contact of the heat-developable light-sensitive material with a heat source such as a heating roller or heating drum. As this type of thermally-developing apparatus, the thermally-developing apparatus described in JP-B-5-56499, Japanese Patent No. 684453, JP-A-9-292695, JP-A-9-297385, and WO95/30934 are used.

As a non-contact-type, the apparatus described in JP-A-7-13294 and WO97/28489, WO97/28488, and WO97/28487 are used.

A preferable temperature for development is in the range of 100 to 350° C. and a more preferable temperature for development is in the range of 130 to 200° C. A preferable time for development is in the range of 1 to 60 seconds and a more preferable time for development is in the range of 3 to 30 seconds.

The light-sensitive material and/or the processing material for use in the present invention may be in the form that has an electroconductive heat-generating material layer as a heating means for heat development. In this case, as the heat-generating element, one described, for example, in JP-A-61-145544 can be employed.

The heating mode is as follows. The light-sensitive material in a state of a film after photographing is normally separated from a magazine or cartridge and the heat-development processing is carried out using the film in a naked state. For example, a method disclosed in JP-A-2000-171961, in which heat development is carried out while the film is being pulled out of a thrust cartridge and, at the time point when the development of the final part is over, the film after processing is again loaded in the thrust cartridge, is also preferable.

Alternatively, a light-sensitive material, which is enclosed in a magazine or cartridge by being rolled, may undergo heat development by heating the entire container from outside.

(Read Out)

In the present invention, it is necessary to read out the image formed on the light-sensitive material after heat development, and to convert the image information into digital signals. As the apparatus for reading out the image, an image input device that is generally known can be used. Details of the image input device are described, for example, by Takao Andoh, et al., in “Principles of Digital Image Input”, pages 58-98, Corona Publishing Co., Ltd. (1998).

The image input device is required to take in a vast amount of image information in an efficient way. The image input device is roughly divided into a linear sensor and an area sensor, in terms of the arrangement of fine point sensors. The former comprises a large number of point sensors arranged on a line. When it is used for taking in a planar image, either the light-sensitive material side or the sensor side needs to be scanned. Therefore, although the readout requires a little longer time, the manufacturing cost of the former sensor is inexpensive, which is one of merits. As for the area sensor, since readout can be made basically without scanning of the light-sensitive material or the sensor, a large-sized sensor needs to be used although the readout speed is high. Therefore, the cost becomes higher. These sensors can be used selectively according to the purposes and both of them can be used preferably in the present invention.

The kinds of the sensors include an electronic tube-type, such as a photographic tube or an image tube, and a solid-state photographing system, such as CCD-type or MOS-type. In view of costs and ease in handling, a solid-state photographing system, in particular a CCD-type, is preferable.

As for the apparatus installed with such an image input device, although commercially avairable digital still cameras, drum scanners, flat bed scanners, film scanners, and the like can be used, the use of a film scanner is preferable in order to read out a high-quality image in an easy and simple manner.

Typical commercialized film scanners include those using a linear CCD, such as Nikon•Film Scanner LS-1000 (trade name), Agfa•Duoscan HiD (trade name), Imacon•Flextightphoto (trade name), and the like. In addition, Kodak RFS3570 (trade name), and the like, which use an area CCD, can be preferably used.

Further, the image input device by using an area CCD, which is installed in Digital Print System•Frontier (trade name) manufactured by Fuji Photo Film Co., Ltd., can also be preferably used. Furthermore, the image input device of Digital Print System•Frontier F350 (trade name) manufactured by Fuji Film, which realizes high-quality image readout in a high speed, even by using a liner CCD sensor, as described by Yoshio Ozawa, et al. in Fuji Film Research Report No. 45, pages 35-41, is particularly suitable to the readout of the light-sensitive material of the present invention.

(Image Processing)

In the present invention, after the formation of a color-formed image on the light-sensitive material by heat-development, a color image can be obtained on another recording material based on the thus-obtained image information. The method for outputting on another material based on image information may be a method, in which the image information is photoelectrically read out by measuring the density of transmitted light, the image information is then converted into digital signals, and after image processing, output onto the another material is made in accordance with the signals obtained. The material on which the output is made does not need to be a light-sensitive material using a silver halide. For example, the material may be a sublimation-type heat-sensitive recording material, a full-color direct heat-sensitive recording material, a material for ink-jet, or an electrophotographic material.

As image-processing methods that can be preferably applied to the image-forming method of the present invention, for example, following methods can be mentioned.

In JP-A-6-139323, an image-processing system and an image-processing method that can faithfully reproduce a color of the subject from a negative film, wherein an image of a subject is produced on a color-negative, and then the image is converted to corresponding image data using a scanner or the like, and the same color as that of the subject is then outputted based on the demodulated color information, are mentioned, and they can be used in the present invention.

Further, as an image-processing method wherein graininess and noise of a digitized image are suppressed and sharpness is enhanced at the same time, a method to conduct weighting and fractionating processing to the edge and noise of an image, based on sharpness enhanced image data, smoothed image data, and edge detected data, as described in JP-A-10-243238; or an image-processing method to conduct weighting and fractionating processing, with obtaining an edge component from sharpness enhanced image data and smoothed image data, as described in JP-A-10-243239, can be used.

Further, to compensate fluctuation in color reproducibility in the final print, which are caused by differences, such as storage condition and processing condition of photographing materials, with a digital color print system, a method disclosed in JP-A-10-255037 can be used, wherein a patch having four steps or four colors or more is exposed to light on an unexposed part of a photographic material for shooting, and, after development, the patch density is measured, to obtain a look-up table and a color conversion matrix required for compensation, and thus colors of a photographic image are compensated by using look-up table conversion or performing matrix operations.

As a method for converting a color-reproduction range (gamut) of image data, use can be made of a method, wherein, for an image data displayed by a color signal that is visually recognized to be a neutral color when values of each color component are made available, the color signal is divided into components of chromatic colors and components of achromatic colors, and each of them are individually processed, as described in JP-A-10-229502.

Furthermore, as an image-processing method for removing the deterioration of an image, in the image photographed by a camera, such as aberration and lowering of brightness of the edge of the image field caused by a camera lens, use can be made of an image-processing method and apparatus that compensate digital image data, wherein a lattice-like compensation pattern to create compensation data for the image deterioration is preliminary recorded on a film, and then after photographing, both the image and the compensation pattern are read out by the film scanner or the like, to create data to compensate deterioration factors caused by the lens of a camera, and then by using the image-deterioration-compensation data, digital image data is compensated, as described in JP-A-11-69277.

Furthermore, as a method for compressing a color signal, use can be made, for example, of a method described in JP-A-11-113023, wherein the color signal of each picture element is separated into a lightness component and a chromaticity component, and, by selecting, for the chromaticity component, a template having the most suitable value patterns out of plural hue templates prepared in advance, hue information is encoded.

According to the heat-developable silver halide color photographic light-sensitive material of the present invention, for example, a monosheet-type heat-developable color light-sensitive material for shooting, the curling problem of the light-sensitive material can be overcome even if the light-sensitive material is heated and processed at a high temperature such as a temperature of 130° C. or above. As a result, no trouble is encountered in the readout by a scanner or the like, and readout to produce a high-quality image (at a high resolution with less scattering of resolution) is possible.

The present invention is described in more detail with reference to the following examples, but the present invention is not limited thereto.

### EXAMPLES

### Example 1

<Manufacture of Various Films for Supports>

(1) Manufacture of Polyethylene Terephthalate (PET) Film

PET having a degree of polymerization of about 100 was obtained from terephthalic acid and ethylene glycol by an esterification reaction in a usual manner. The PET thus obtained was pelletized and the pellets were dried at 130° C. for 4 hours. After that, the pellets were melted at 300° C. and the melt was extruded from a T-shaped die onto a cooling drum so that a film was formed. Then, the film was stretched 3 to 4 times the original length in the longitudinal direction by using the difference of peripheral speeds of rollers at 110° C. in a longitudinal stretching zone, and successively stretched 3 to 4 times the original width in the transverse direction at 130° C. while holding the both film edges by means of a tenter. The resultant film was then subjected to, at 240° C. for 20 seconds, crystallization, and thermal fixing. In this way, a PET support having a thickness of 100 μm was obtained. Tg of this film was 76° C.

(2) Manufacture of Polyethylene Naphthalate (PEN) Film

Polyethylene-2,6-naphthalate was obtained by polymerization, using 2,6-naphthalenedicarboxylic acid dimethyl ester and ethylene glycol, as starting materials, and adding 50 ppm of spherical silica particles having an average particle diameter of 0.3 μm, by transesterification in a usual manner. The PEN thus obtained was pelletized and the pellets were dried at 170° C. for 4 hours. After that, the pellets were melted at 300° C. and the melt was extruded from a T-shaped die. Thereafter, the extruded film was quenched. Then, the resultant film was stretched 3.0 times the original length in the longitudinal direction and successively stretched 3.3 times the original width in the transverse direction. The stretching temperatures were 140° C. and 130° C., respectively. The stretched film was then subjected to, at 250° C. for 20 seconds, thermal fixing and was then relaxed 3% in the transverse direction. The resultant film was wound up by 4 kg/cm² as in the case of the PET mentioned above. In this way, a support film having a thickness of 100 μm was obtained in the state of a roll. Tg of this film was 119° C.

(3) Manufacture of Polycarbonate (PC) Film

PC was synthesized by carrying out an interfacial polymerization reaction between two phases, i.e., a methylene chloride phase and a phase of a bisphenol A solution prepared by dissolving bisphenol A in an aqueous solution of sodium hydroxide. Thus, a PC plastic having good transparency and less yellowish tint was obtained, though the molecular weight distribution of the plastic was somewhat broad. From the pellets of this PC, an unstretched PC film having a thickness of 100 μm was obtained by melt extrusion at 350° C. Tg of this film was 150° C.

(4) Manufacture of Polyarylate (PAR) Film

Polyarylate having high transparency was obtained, by carrying out an interfacial polymerization reaction between a mixture of tere/isophthaloyl chlorides dissolved in methylene chloride and bisphenol A dissolved in an aqueous solution of sodium hydroxide. From the pellets of this PAR, an unstretched PAR film having a thickness of 100 μtm was obtained, by melt extrusion at 350° C. Tg of this film was 193° C.

(5) Manufacture of Polyethersulfone (PES) Film

Generally, PES is obtained by a process comprising the steps of: reacting dichlorodiphenylsulfone, bisphenol S. and potassium carbonate in a high boiling point solvent, and, removing potassium chloride and the high boiling point solvent. In the present example, a commercially available PES, i.e., Victorex PES (trade name) manufactured by ICI Ltd., was used. From this PES, an unstretched PES film having a thickness of 100 μm was obtained, by melt extrusion at 350° C. Tg of this film was 225° C.

<Manufacture of Supports for Light-sensitive Materials>

Supports for light-sensitive materials were manufactured by combining the above-described films with the surface treatment and undercoat selected from those described below.

(1) Surface Treatment

(1-1) Corona Treatment

Both sides of the support were treated at 20 m/minute at room temperature, using a solid state corona processor (model 6KVA) manufactured by Pillar Corp. Based on the current and voltage readings, the film underwent a treatment of 0.375kV·A·minute/m². At the time of this treatment, the frequency employed was 9.6 kHz and the gap clearance between the electrode and the dielectric roll was 1.6 mm.

(1-2) Glow Discharge Treatment

The glow discharge treatment was carried out in accordance with Example 1 described in Journal of Technical Disclosure No. 94-6023 issued from The Japan Institution of Innovation and Invention.

(2) Undercoating

(2-1) Formulation of Undercoating Layer

(Formulation (1))

An undercoating solution of the following composition was applied using a wire bar at 6 ml/m², and the resultant layer was dried at 120° C. for 2 minutes.

| | |
|---|---|
| Butadiene/styrene copolymer latex | 13 ml |
| (solid components: 43%, butadiene/styrene weight | |
| ratio = 32/68) | |
| 8% aqueous solution of 2,4-dichloro-6-hydroxy-S- | 7 ml |
| triazine sodium salt | |
| 1% aqueous solution of sodium laurylbenzenesulfonate | 1.6 ml |
| Distilled water | 80 ml |
| (Formulation (2)) | |

An undercoating solution of the following composition was applied using a wire bar at 9 ml/m², and the resultant layer was dried at 185° C. for 5 minutes.

| | |
|---|---|
| Gelatin | 0.9 g |
| Methyl cellulose | 0.1 g |
| (Metholose SM15 (trade name), degree of substitution: | |
| 1.79˜1.83) | |
| Acetic acid (concentration: 99%) | 0.02 ml |
| Distilled water | 99 ml |
| (Formulation (3)) | |

An undercoating solution of the following composition was applied using a wire bar at 6 ml/m², and the resultant layer was dried at 120° C. for 2 minutes.

| | |
|---|---|
| Butadiene/styrene copolymer latex | 13 ml |
| (solid components: 43%, butadiene/styrene weight ratio = | |
| 32/68) | |
| 1% aqueous solution of sodium laurylbenzenesulfonate | 1.6 ml |
| Distilled water | 87 ml |
| (Formulation (4)) | |

An undercoating solution of the following composition was applied using a wire bar, and the resultant layer was dried at 185° C. for 5 minutes.

| | |
|---|---|
| SnO₂/Sb (9/1 by weight ratio, average particle diameter: | 100 mg/m² |
| 0.25 μm) | |
| Gelatin | 77 mg/m² |
| Sodium dodecylbenzenesulfonate | 1 mg/m² |
| Sodium dihexyl-α-sulfosuccinate | 4 mg/m² |
| (3) Thermal treatment | |

A thermal treatment of the following methods was carried out according to the selected procedure, as shown in Table 1.

(3-1) Thermal Treatment While Being Transferred

A support after being surface-treated and, if necessary, undercoated as described above in item (2) was caused to pass through a thermal treatment zone having a total length of 200 m and set to the temperature and tension, as shown in Table 1, at a travel speed of 20 m/minute.

After the thermal treatment, the resultant support was subjected to post-thermal-treatment at the time period and temperature, as shown in Table 1, and thereafter wound. The windup tension was 10 kg/mm².

(3-2) Post-thermal-treatment of the Roll

The thus-treated support was wound into a state of roll by a tension of 4 kg/cm², and the wound support was kept at 115° C. for 48 hours while being rotated at a rate of 0.2 turns/hour. After that, the resultant support roll was cooled to room temperature while being rotated.

<Coating of Backing Layer>

(1st Backing Layer)

The undercoat layer on the back side of the support was overcoated with the 1st backing layer in such a manner that the following components were coated at respective coating amounts shown below. Besides, the coating amount of gelatin on the back side of the support was adjusted, if necessary, by increasing or decreasing the coating amounts of the components without changing the compositional proportions thereof wherein the following coating amount level was taken as 1.

| | |
|---|---|
| Gelatin | 10.0 g/m² |
| Surfactant (Triton X-200 (trade name)) | 0.05 g/m² |
| Potassium nitrate | 0.20 g/m² |
| Poly(ethyl acrylate) latex | 0.5 g/m² |
| (having an average particle diameter of 50 nm) | |
| (2nd backing layer) | |

The 1st backing layer was overcoated with the 2nd backing layer in such a manner that the following components were coated at respective coating amounts shown below.

| | |
|---|---|
| Gelatin | 2.0 g/m² |
| Surfactant (Aerosol OT (Trade name)) | 0.05 g/m² |
| Silica fine-particles (having an average particle | 0.1 g/m² |
| diameter of 2.5 μm) | |
| 1,2-(bis-vinylsulfoneacetamido)ethane | 0.06 g/m² |

By combining the above-described supports with or without the backing layers, support samples, if necessary, provided with the backing layers, as shown in Table 1, were manufactured.

TABLE 1

| | | | | Coating amount | Thermal | | Post-thermal | |
|---|---|---|---|---|---|---|---|---|
| | | | Film | of gelatin on | treatment | | treatment | |
| Sample | Film | Tg | thickness | back side of | Temp. | Tension | Temp. | Time |
| No. | material | (° C.) | (μm) | support (g/m²) | (° C.) | (kg/cm²) | (° C.) | (sec) |
| 101 | PET | 76 | 100 | 0 | 125 | 3 | 40 | 15 |
| 102 | PEN | 119 | 100 | 0 | 180 | 3 | 40 | 15 |
| 103 | PC | 150 | 100 | 0 | 210 | 3 | 40 | 15 |
| 104 | PAR | 193 | 100 | 0 | 243 | 3 | 40 | 15 |
| 105 | PES | 225 | 100 | 0 | 270 | 3 | 40 | 15 |
| 106 | PET | 76 | 100 | 2 | 125 | 3 | 40 | 15 |
| 107 | PET | 76 | 100 | 6 | 125 | 3 | 40 | 15 |
| 108 | PET | 76 | 100 | 12 | 125 | 3 | 40 | 15 |
| 109 | PET | 76 | 100 | 24 | 125 | 3 | 40 | 15 |
| 110 | PEN | 119 | 100 | 12 | 180 | 3 | 40 | 15 |
| 111 | PES | 225 | 100 | 12 | 270 | 3 | 40 | 15 |
| 201 | PET | 76 | 100 | 0 | 125 | 3 | 40 | 15 |
| 202 | PEN | 119 | 100 | 0 | 180 | 3 | 40 | 15 |
| 203 | PES | 225 | 100 | 0 | 270 | 3 | 40 | 15 |
| 204 | PEN | 119 | 100 | 12 | 180 | 3 | 40 | 15 |
| 205 | PES | 225 | 100 | 12 | 270 | 3 | 40 | 15 |

<Preparation of High-sensitivity Silver Halide Emulsion>

0.37 g of gelatin having an average molecular weight of 15,000, 0.37 g of acid-processed gelatin, and 930 ml of distilled water containing 0.7 g of potassium bromide, were placed in a reaction vessel, and the temperature was elevated to 38° C. To the resulting solution, were added 30 ml of an aqueous solution containing 0.34 g of silver nitrate and 30 ml of an aqueous solution containing 0.24 g of potassium bromide, over 20 sec, with vigorous stirring. After the completion of the addition, the temperature was kept at 40° C. for 1 min, and then, the temperature of the reaction liquid was raised to 75° C. After 27.0 g of gelatin whose amino group was modified with trimellitic acid, was added, together with 200 ml of distilled water, 100 ml of an aqueous solution containing 23.36 g of silver nitrate, and 80 ml of an aqueous solution containing 16.37 g of potassium bromide, were added, over 36 min, with the flow rate of the addition being accelerated. Then, 250 ml of an aqueous solution containing 83.2 g of silver nitrate, and an aqueous solution containing potassium iodide and potassium bromide in a molar ratio of 3:97 (the concentration of potassium bromide: 26%), were added, over 60 min, with the flow rate of the addition being accelerated, so that the silver electric potential of the reaction liquid would become −50 mV to a saturated calomel electrode. Further, 75 ml of an aqueous solution containing 18.7 g of silver nitrate, and a 21.9% aqueous solution of potassium bromide, were added, over 10 min, so that the silver electric potential of the reaction liquid would become 0 mV to the saturated calomel electrode. After the completion of the addition, the temperature was kept at 75° C. for 1 min; then the temperature of the reaction liquid was dropped to 40° C. Then, thereto, 100 ml of an aqueous solution containing 10.5 g of sodium p-iodoacetamidobenzenesulfonate (monchydrate) was added, and the pH of the reaction liquid was adjusted to 9.0. Further, 50 ml of an aqueous solution containing 4.3 g of sodium sulfite was added. After the completion of the addition, the temperature was kept 40° C. for 3 min, and the temperature of the reaction liquid was raised to 55° C. After adjusting the pH of the reaction liquid to 5.8, 0.8 mg of sodium benzenethiosulfinate, 0.04 mg of potassium hexachloroiridate (IV), and 5.5 g of potassium bromide were added, kept at 55° C. for 1 min, and further, 180 ml of an aqueous solution containing 44.3 g of silver nitrate, and 160 ml of an aqueous solution containing 34.0 g of potassium bromide and 8.9 mg of potassium hexacyanoferrate (II), were added over 30 min. The temperature was then dropped, and then desalting was carried out by a usual method. After the completion of the desalting, gelatin was added to be 7% by mass, and pH was adjusted to 6.2.

The resulting emulsion was an emulsion containing hexagonal tabular grains, wherein the average grain size (represented by a sphere-equivalent diameter, which is a diameter of a sphere having the volume equivalent to an individual grain) was 1.15 μm, the average grain thickness was 0.12 μm, and the average aspect ratio (a ratio obtained by dividing the projected grain diameter by the grain thickness) was 24.0. This emulsion was designated as Emulsion A-1.

By changing the amounts of silver nitrate and potassium bromide that were added at the first of the formation of grains, the number of nuclei to be formed was changed from those adopted in the case of Emulsion A-1, to prepare Emulsion A-2, comprising hexagonal tabular grains having an average grain size of 0.75 μm in terms of diameter equivalent to a sphere, an average grain thickness of 0.11 μm, and an average aspect ratio of 14.0, and Emulsion A-3, comprising hexagonal tabular grains having an average grain size of 0.52 μm in terms of diameter equivalent to a sphere, an average grain thickness of 0.09 μm, and an average aspect ratio of 11.3. In these cases, the amounts to be added of potassium hexachloroiridate (IV) and potassium hexacyanoferrate (II) were changed in inverse proportion to the volume of grains, and the amount to be added of sodium p-iodoacetoamidobenzenesulfonate monohydrate was changed in proportion to the circumferential length of an individual grain.

5.6 ml of an aqueous 1% potassium iodide solution was added to the Emulsion A-1 at a temperature of 40° C., to which were then added 8.2×10⁻⁴ mol of the following spectrally-sensitizing dye I for blue-sensitive emulsion, Compound I, potassium thiocyanate, chloroauric acid, sodium thiosulfate, and mono(pentafluorophenyl) diphenylphosphineselenide, to carry out spectral sensitization and chemical sensitization. After the chemical sensitization was completed, 1.2×10⁻⁴ mol of Stabilizer S was added. At this time, the amounts of the chemical sensitizers were adjusted so as to make the level of chemical sensitization for the emulsion optimal.

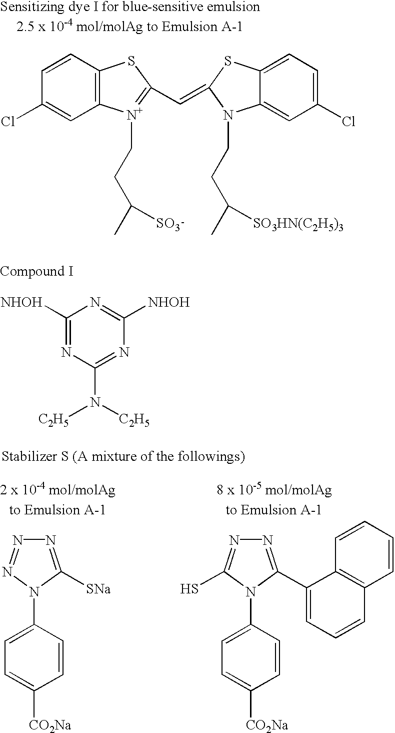

The resulting blue-sensitive emulsion was designated to as Emulsion A-1b. Similarly, by subjecting spectral sensitization and chemical sensitization to each emulsion of the above A-2 and A-3, Emulsions A-2b and A-3b were prepared, respectively. The amounts of the spectrally-sensitizing dyes to be added were changed in accordance with the surface area of an individual grain of the silver halide in each emulsion. Further, the amount of each chemical to be used for the chemical sensitization was controlled so that the degree of the chemical sensitization to each emulsion would be optimal.

Similarly, by changing the spectrally-sensitizing dyes to the following dyes, respectively, Green-sensitive emulsions A-1g, A-2g, and A-3g, and Red-sensitive emulsions A-1r, A-2r and A-3r, were prepared, respectively.

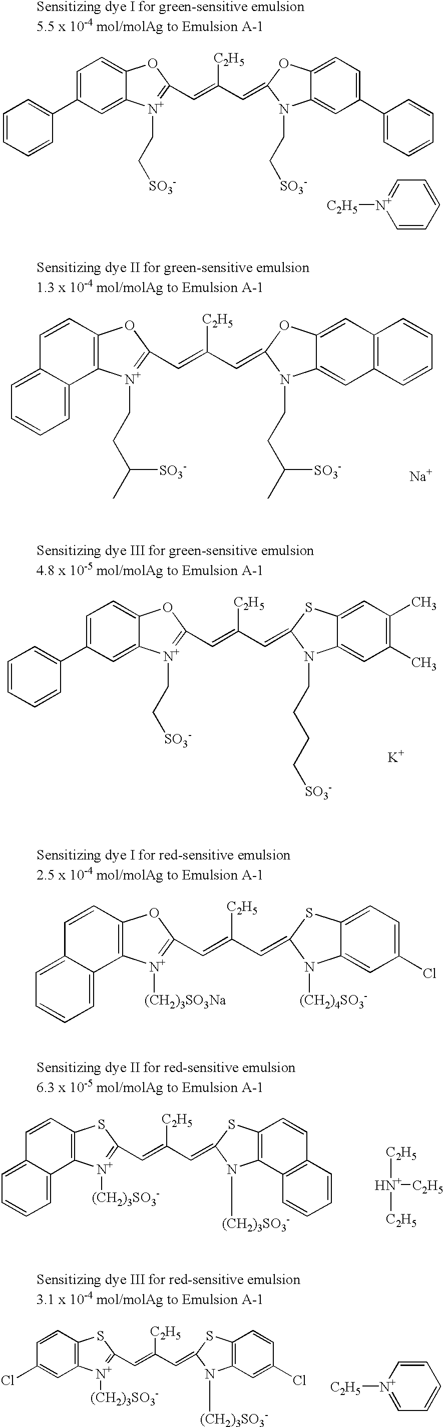

<Method for Preparing Silver 5-butylbenzotriazole>

1.0 g of 5-butylbenzotriazole, 0.24 g of sodium hydroxide, and 25 g of phthalated gelatin were dissolved in 700 ml of water. The resultant solution was kept at 60° C. and stirred. Then, to the resulting solution, were added a solution prepared by dissolving 5 g of 5-butylbenzotriazole and 1.2 g of sodium hydroxide in 150 ml of water, and a solution prepared by dissolving 5 g of silver nitrate in 150 ml of water, simultaneously, over a period of 4 minutes. The resulting solution was stirred for 5 minutes. After that, to the solution, were added a solution prepared by dissolving 5 g of 5-butylbenzotriazole and 1.2 g of sodium hydroxide in 150 ml of water, and a solution prepared by dissolving 5 g of silver nitrate in 150 ml of water, simultaneously, over a period of 6 minutes. The pH of the resulting emulsion was adjusted so as to cause precipitation and excess salt was removed. After that, the pH was adjusted to 6.0, and a silver 5-butylbenzotriazole emulsion in an yield of 470 g was obtained.

<Preparation of Dispersion (a) of Solid Fine-particles of a Base Precursor>

64 g of a base precursor compound BP-35, and 10 g of a surfactant Demol N (trade name) manufactured by Kao Corp. were mixed with 220 ml of distilled water, and the mixed solution was subjected to beads dispersion using a sand mill (¼ Gallon sand grinder mill, manufactured by Imex Co.), to obtain Dispersion (a) of solid fine-particles of the base precursor compound, having an average particle diameter of 0.2 μm.

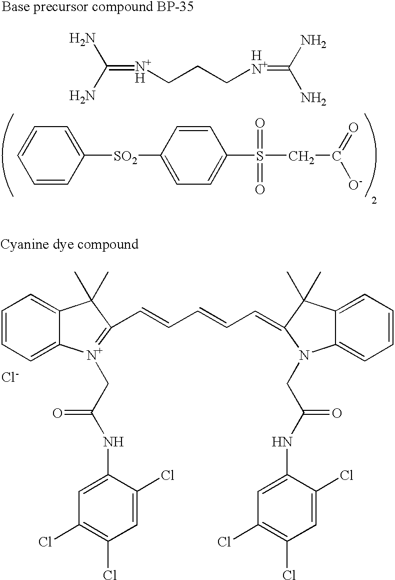

<Preparation of Dispersion of Solid Fine-particles of a Dye>

9.6 g of a cyanine dye compound shown in the above and 5.8 g of sodium p-dodecylbenzenesulfonate were mixed with 305 ml of distilled water, and the mixed solution was subjected to beads dispersion using a sand mill (¼ Gallon sand grinder mill, manufactured by Imex Co.), to obtain a dispersion of solid fine-particles of the dye having an average particle diameter of 0.2 μm.

<Preparation of an Anti-halation Layer Coating Solution>

17 g of gelatin, 9.6 g of polyacrylamide, 70 g of the above Dispersion (a) of solid fine-particles of the base precursor, 56 g of the above dispersion of solid fine-particles of the dye, 1.5 g of fine-particulate polymethyl methacrylate (average particle size: 6.5 μm), 0.03 g of benzoisothiazolinone, 2.2 g of sodium polyethylenesulfonate, 0.2 g of the following blue-coloring dye compound 14, 3.9 g of the following yellow-coloring dye compound 15, and 844 ml of water, were mixed, to prepare an anti-halation layer coating solution.

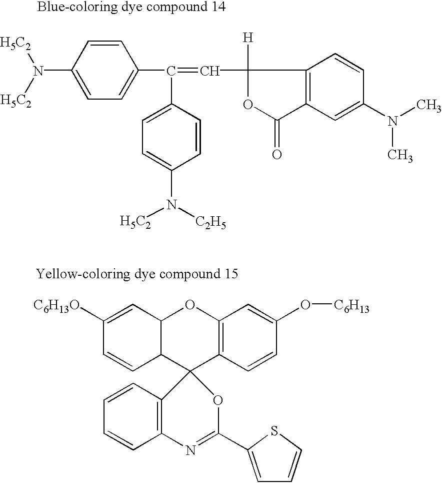

<Preparation of Dispersions of Fine-crystalline Particles of a Color-developing Agent, a Coupler, and a Thermal Solvent>

The dispersions of fine crystals of a color-developing agent (DDEV-1), a coupler (Y-1, M-1, C-1), and a thermal solvent (TS-1) were all prepared according to the following method. To a mixture of 50 g of the intended compound and 30 g of a 10% by mass aqueous solution of modified polyvinyl alcohol (Poval MP203, trade name, manufactured by Kuraray Co., Ltd.), were added 0.5 g of Alkanol XC (trade name) and 100 g of water, and these were mixed well so as to prepare a slurry. The slurry was fed by means of a diaphragm pump and dispersed for 6 hours in a horizontal sand mill (UVM-2, trade name, manufactured by Imex Co., Ltd.) loaded with zirconia beads having an average diameter of 0.5 mm. After that, water was added to the dispersion thus obtained such that the concentration of the intended compound would be 10% by mass. In this way, the dispersion of the intended compound was obtained. The particles contained in the thus-prepared dispersion of the intended compound had a median diameter of 0.40 μm and a maximum particle diameter of 2.0 μm or less. The dispersion of the intended compound was filtered through a polypropylene filter having a pore diameter of 10.0 μm so that foreign matters, such as foreign particles, were eliminated. After that, the dispersion was stored. Immediately before use, the dispersion was filtered again through a polypropylene filter having a pore diameter of 10 μm.

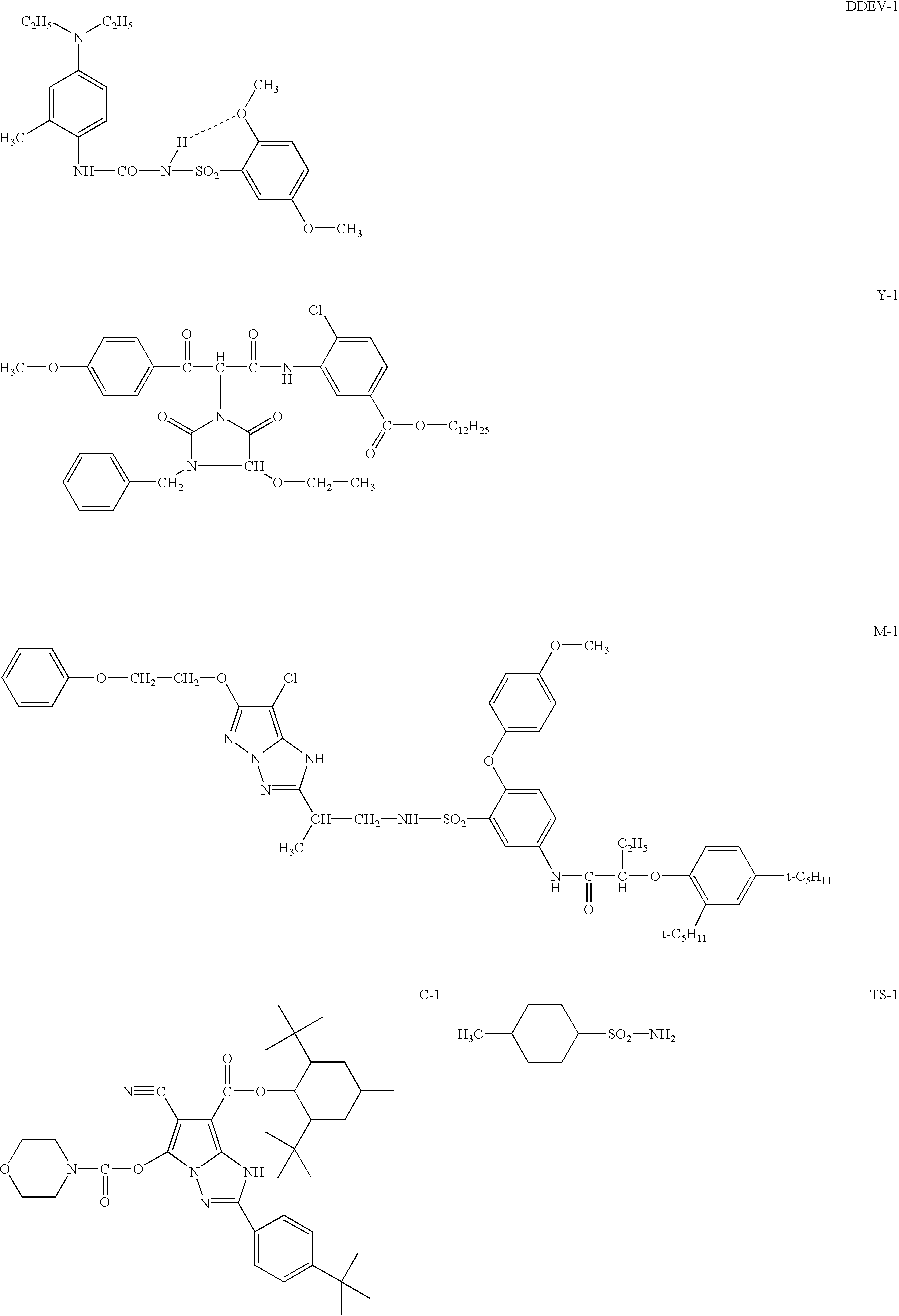

By using these emulsions, dispersions, support, and the like, multilayer color heat-developable light-sensitive material samples, as shown in Table 2, were prepared.

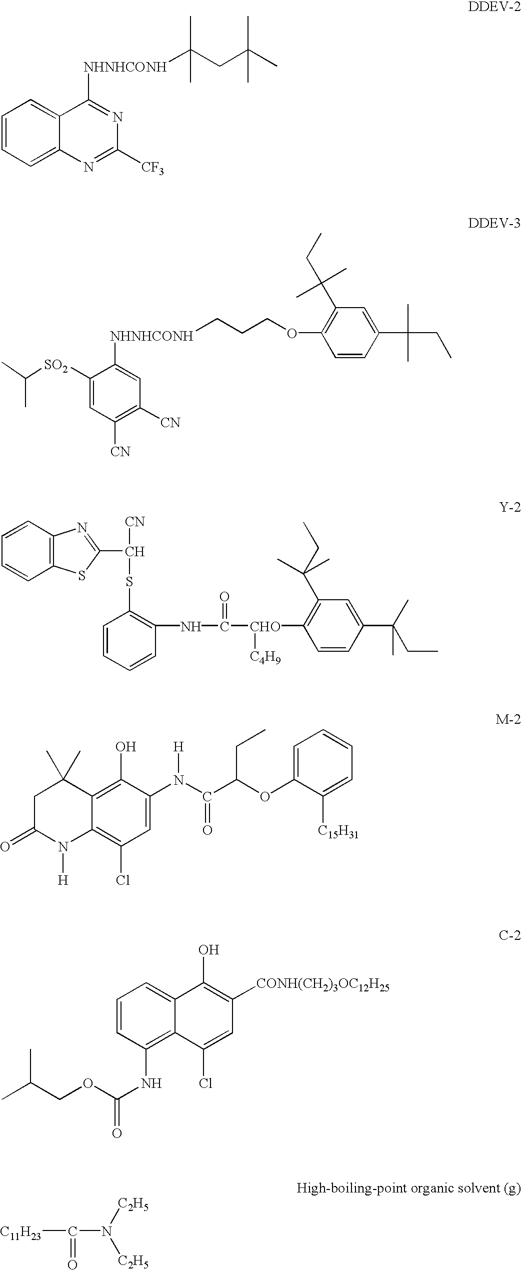

TABLE 2
Support with/without backing layer, as shown in Table 1

| | | Coating | | Coating |
|---|---|---|---|---|
| | | amount | | amount |
| | Samples 101 ˜ 111 | (mg/m²) | Samples 201 ˜ 205 | (mg/m²) |
| Protective | Lime-processed gelatin | 914 | Lime-processed gelatin | 914 |
| layer | Matt agent (silica) | 50 | Matt agent (silica) | 50 |
| | Surfactant (q) | 30 | Surfactant (q) | 30 |
| | Surfactant (r) | 40 | Surfactant (r) | 40 |
| | Water soluble polymer (s) | 15 | Water soluble polymer (s) | 15 |
| | Hardener (t) | 110 | Hardener (t) | 110 |
| Intermediate | Lime-processed gelatin | 461 | Lime-processed gelatin | 461 |
| layer | Surfactant (r) | 5 | Surfactant (r) | 5 |
| | Formalin scavenger (u) | 300 | Formalin scavenger (u) | 300 |
| | Water soluble polymer (s) | 15 | Water soluble polymer (s) | 15 |
| Yellow-color | Lime-processed gelatin | 1750 | Lime-processed gelatin | 1750 |
| forming | Emulsion (in terms of | A-1b | Emulsion (in terms of | A-1b |
| layer | coating amount of silver) | 550 | coating amount of silver) | 550 |
| (high- | Silver 5-butyl-benzotriazole | 165 | Silver 5-butyl-benzotriazole | 165 |
| sensitivity | Yellow coupler (Y-1) | 179 | Yellow coupler (Y-2) | 179 |
| layer) | Color-developing agent | 215 | Color-developing agent | 215 |
| | (DDEV-1) | | (DDEV-2) | |
| | Antifogging agent (d) | 6.2 | Antifogging agent (d) | 6.2 |
| | Surfactant (y) | 27 | Surfactant (y) | 27 |
| | Thermal solvent (TS-1) | 350 | High-boiling organic | 197 |
| | | | solvent (g) | |
| | | | Thermal solvent (TS-1) | 350 |
| Yellow-color | Lime-processed gelatin | 1470 | Lime-processed gelatin | 1470 |
| forming | Emulsion (in terms of | A-2b | Emulsion (in terms of | A-2b |
| layer | coating amount of silver) | 263 | coating amount of silver) | 263 |
| (medium- | Silver 5-butyl-benzotriazole | 185 | Silver 5-butyl-benzotriazole | 185 |
| sensitivity | Yellow coupler (Y-1) | 269 | Yellow coupler (Y-2) | 269 |
| layer) | Color-developing agent | 323 | Color-developing agent | 323 |
| | (DDEV-1) | | (DDEV-2) | |
| | Antifogging agent (d) | 5.9 | Antifogging agent (d) | 5.9 |
| | Surfactant (y) | 26 | Surfactant (y) | 26 |
| | Thermal solvent (TS-1) | 294 | High-boiling organic | 296 |
| | | | solvent (g) | |
| | | | Thermal solvent (TS-1) | 294 |
| Yellow-color | Lime-processed gelatin | 1680 | Lime-processed gelatin | 1680 |
| forming layer | Emulsion (in terms of | A-3b | Emulsion (in terms of | A-3b |
| (low- | coating amount of silver) | 240 | coating amount of silver) | 240 |
| sensitivity | Silver 5-butyl-benzotriazole | 206 | Silver 5-butyl-benzotriazole | 206 |
| layer) | Yellow coupler (Y-1) | 448 | Yellow coupler (Y-2) | 448 |
| | Color-developing agent | 539 | Color-developing agent | 539 |
| | (DDEV-1) | | (DDEV-2) | |
| | Antifogging agent (d) | 5.4 | Antifogging agent (d) | 5.4 |
| | Surfactant (y) | 30 | Surfactant (y) | 30 |
| | Thermal solvent (TS-1) | 336 | High-boiling organic | 493 |
| | | | solvent (g) | |
| | | | Thermal solvent (TS-1) | 336 |
| Intermediate | Lime-processed gelatin | 560 | Lime-processed gelatin | 560 |
| layer | Surfactant (y) | 15 | Surfactant (y) | 15 |
| | Water soluble polymer (s) | 15 | Water soluble polymer (s) | 15 |
| Magenta | Lime-processed gelatin | 781 | Lime-processed gelatin | 781 |
| color-forming | Emulsion (in terms of | A-1g | Emulsion (in terms of | A-1g |
| layer | coating amount of silver) | 488 | coating amount of silver) | 488 |
| (high- | Silver 5-butyl-benzotriazole | 62 | Silver 5-butyl-benzotriazole | 62 |
| sensitivity | Magenta coupler (M-1) | 47 | Magenta coupler (M-2) | 47 |
| layer) | Color-developing agent | 81 | Color-developing agent | 81 |
| | (DDEV-1) | | (DDEV-2) | |
| | Antifogging agent (d) | 5.5 | Antifogging agent (d) | 5.5 |
| | Surfactant (y) | 8 | Surfactant (y) | 8 |
| | Thermal solvent (TS-1) | 156 | High-boiling organic | 64 |
| | | | solvent (g) | |
| | | | Thermal solvent (TS-1) | 156 |
| Magenta | Lime-processed gelatin | 659 | Lime-processed gelatin | 659 |
| color-forming | Emulsion (in terms of | A-2g | Emulsion (in terms of | A-2g |
| layer | coating amount of silver) | 492 | coating amount of silver) | 492 |
| (medium- | Silver 5-butyl-benzotriazole | 93 | Silver 5-butyl-benzotriazole | 93 |
| sensitivity | Magenta coupler (M-1) | 94 | Magenta coupler (M-2) | 94 |
| layer) | Color-developing agent | 163 | Color-developing agent | 163 |
| | (DDEV-1) | | (DDEV-2) | |
| | Antifogging agent (d) | 11.1 | Antifogging agent (d) | 11.1 |
| | Surfactant (y) | 11 | Surfactant (y) | 11 |
| | Thermal solvent (TS-1) | 132 | High-boiling organic | 128 |
| | | | solvent (g) | |
| | | | Thermal solvent (TS-1) | 132 |
| Magenta | Lime-processed gelatin | 711 | Lime-processed gelatin | 711 |
| color- | Emulsion (in terms of | A-3g | Emulsion (in terms of | A-3g |
| forming | coating amount of silver) | 240 | coating amount of silver) | 240 |
| layer | Silver 5-butyl-benzotriazole | 155 | Silver 5-butyl-benzotriazole | 155 |
| (low- | Magenta coupler (M-1) | 234 | Magenta coupler (M-2) | 234 |
| sensitivity | Color-developing agent | 407 | Color-developing agent | 407 |
| layer) | (DDEV-1) | | (DDEV-2) | |
| | Antifogging agent (d) | 5.4 | Antifogging agent (d) | 5.4 |
| | Surfactant (y) | 29 | Surfactant (y) | 29 |
| | Thermal solvent (TS-1) | 142 | High-boiling organic | 320 |
| | | | solvent (g) | |
| | | | Thermal solvent (TS-1) | 142 |
| Intermediate | Lime-processed gelatin | 850 | Lime-processed gelatin | 850 |
| layer | Surfactant (y) | 15 | Surfactant (y) | 15 |
| | Formalin scavenger (u) | 300 | Formalin scavenger (u) | 300 |
| | Water soluble polymer (s) | 15 | Water soluble polymer (s) | 15 |
| Cyan color- | Lime-processed gelatin | 842 | Lime-processed gelatin | 842 |
| forming layer | Emulsion (in terms of | A-1r | Emulsion (in terms of | A-1r |
| (high- | coating amount of silver) | 550 | coating amount of silver) | 550 |
| sensitivity | Silver 5-butyl-benzotriazole | 59 | Silver 5-butyl-benzotriazole | 59 |
| layer) | Cyan coupler (C-1) | 19 | Cyan coupler (C-2) | 19 |
| | Color-developing agent | 77 | Color-developing agent | 77 |
| | (DDEV-1) | | (DDEV-3) | |
| | Antifogging agent (d) | 6.2 | Antifogging agent (d) | 6.2 |
| | Surfactant (y) | 5 | Surfactant (y) | 5 |
| | Thermal solvent (TS-1) | 168 | High-boiling organic | 48 |
| | | | solvent (g) | |
| | | | Thermal solvent (TS-1) | 168 |
| Cyan color- | Lime-processed gelatin | 475 | Lime-processed gelatin | 475 |
| forming | Emulsion (in terms of | A-2r | Emulsion (in terms of | A-2r |
| layer | coating amount of silver) | 600 | coating amount of silver) | 600 |
| (medium- | Silver 5-butyl-benzotriazole | 132 | Silver 5-butyl-benzotriazole | 132 |
| sensitivity | Cyan coupler (C-1) | 56 | Cyan coupler (C-2) | 56 |
| layer) | Color-developing agent | 231 | Color-developing agent | 231 |
| | (DDEV-1) | | (DDEV-3) | |
| | Antifogging agent (d) | 13.5 | Antifogging agent (d) | 13.5 |
| | Surfactant (y) | 10 | Surfactant (y) | 10 |
| | Thermal solvent (TS-1) | 95 | High-boiling organic | 143 |
| | | | solvent (g) | |
| | | | Thermal solvent (TS-1) | 95 |
| Cyan color- | Lime-processed gelatin | 825 | Lime-processed gelatin | 825 |
| forming | Emulsion (in terms of | A-3r | Emulsion (in terms of | A-3r |
| layer | coating amount of silver) | 300 | coating amount of silver) | 300 |
| (low- | Silver 5-butyl-benzotriazole | 157 | Silver 5-butyl-benzotriazole | 157 |
| sensitivity | Cyan coupler (C-1) | 99 | Cyan coupler (C-2) | 99 |
| layer) | Color-developing agent | 411 | Color-developing agent | 411 |
| | (DDEV-1) | | (DDEV-3) | |
| | Antifogging agent (d) | 6.8 | Antifogging agent (d) | 6.8 |
| | Surfactant (y) | 17 | Surfactant (y) | 17 |
| | Thermal solvent (TS-1) | 165 | High-boiling organic | 255 |
| | | | solvent (g) | |
| | | | Thermal solvent (TS-1) | 165 |
| Antihalation | Lime-processed gelatin | 3000 | Lime-processed gelatin | 3000 |
| layer | Surfactant (y) | 30 | Surfactant (y) | 30 |
| | Base precursor BP-35 | 2000 | Base precursor BP-35 | 2000 |
| | Cyanine dye compound | 260 | Cyanine dye compound | 260 |
| | Surfactant (r) | 120 | Surfactant (r) | 120 |
| | Water soluble polymer (s) | 15 | Water soluble polymer (s) | 15 |

The results are shown in Table 3. In this table, it is meant that the larger the RAVE is and the smaller the or is, the better the resolution of a light-sensitive material is.

TABLE 3

| | | | Coating am- | | |
|---|---|---|---|---|---|
| | | | ount of gelatin | | |
| | | Support | on back side | | |
| Sample No. | | Tg (° C.) | (g/m²) | R_{AVE} | σΓ |
| 101 | Comparative example | 76 | 0 | 3.1 | 1.13 |
| 102 | Comparative example | 119 | 0 | 3.5 | 0.75 |
| 103 | This invention | 150 | 0 | 7.0 | 0.71 |
| 104 | This invention | 193 | 0 | 7.8 | 0.79 |
| 105 | This invention | 225 | 0 | 7.8 | 0.79 |
| 106 | This invention | 76 | 2 | 5.5 | 1.17 |
| 107 | This invention | 76 | 6 | 7.0 | 0.71 |
| 108 | This invention | 76 | 12 | 7.0 | 0.71 |
| 109 | This invention | 76 | 24 | 5.1 | 1.31 |
| 110 | This invention | 119 | 12 | 7.7 | 0.84 |
| 111 | This invention | 225 | 12 | 8.6 | 0.55 |
| 201 | Comparative example | 76 | 0 | 3.7 | 1.35 |
| 202 | Comparative example | 119 | 0 | 4.1 | 1.58 |
| 203 | This invention | 225 | 0 | 7.6 | 0.49 |
| 204 | This invention | 119 | 12 | 7.5 | 0.77 |
| 205 | This invention | 225 | 12 | 8.4 | 0.55 |

As can be understood from the results, it is apparent that the resolution at the time of readout by scanner was excellent, with respect to the samples according to the present invention, in which the support film had the Tg value within the range of 120 to 350° C. and/or the backing layer contained a hydrophilic binder (gelatin).

Having described our invention as related to the present embodiments, it is our intention that the invention not be limited by any of the details of the description, unless otherwise specified, but rather be construed broadly within its spirit and scope as set out in the accompanying claims.

What I claim is:

1. A heat-developable silver halide color photographic light-sensitive material, which has a support, and which contains, on the support, a photosensitive silver halide, an organosilver salt, a developing agent, and a coupler that is capable of forming a dye upon a coupling reaction with an oxidized product of the developing agent,
wherein the light-sensitive material satisfies the following condition:
(A) that the support is a plastic film whose glass-transition temperature is 120° C. or higher, but 350° C. or lower; and/or
(B) that the light-sensitive material contains a hydrophilic binder on the support, and a non-light-sensitive layer containing a hydrophilic binder is provided on the side opposite to a light-sensitive layer side, with the support being between the layers, and the light-sensitive layer contains the photosensitive silver halide.

2. The heat-developable silver halide color photographic light-sensitive material according to claim 1, which satisfies the condition (A).

3. The heat-developable silver halide color photographic light-sensitive material according to claim 2, wherein the plastic film is composed of a plastic selected from the group consisting of a polycarbonate, a polysulfone, a polyarylate, a polyethersulfone, a polyparabanic acid, a thermoplastic polyimide, a polyamideimide, a polyetheretherketone, a polyetherimide, a full-aromatic polyamide, and a half-aromatic polyamide.

4. The heat-developable silver halide color photographic light-sensitive material according to claim 1, which satisfies the condition (B).

5. The heat-developable silver halide color photographic light-sensitive material according to claim 4, wherein the main component of the hydrophilic binder is gelatin.

6. The heat-developable silver halide color photographic light-sensitive material according to claim 5, wherein the amount of the gelatin contained in the light-sensitive layer is within the range of 5 to 20 g/m², and the amount of the gelatin contained in the non-light-sensitive layer provided on the side opposite to the light-sensitive layer side, with the support being between the layers, is within the range of 3 to 20 g/m².

7. The heat-developable silver halide color photographic light-sensitive material according to claim 1, wherein the organosilver salt is a complex of an organic or inorganic silver salt in which the gross stability constant of a ligand to silver ion is within the range of 4.0 to 10.0.

8. The heat-developable silver halide color photographic light-sensitive material according to claim 1, wherein the organosilver salt is selected from the group consisting of: a silver salt of an organic compound having a carboxyl group; a silver salt of a mercapto- or thione-substituted compound having a heterocyclic nucleus, which has 5 or 6 ring atoms such that at least one thereof is nitrogen and other ring atoms include carbon and 2 or less hetero atoms selected from oxygen, sulfur, and nitrogen; a silver salt of a mercapto- or thione-substituted compound having no heterocyclic nucleus; a silver salt of an imino group-containing compound; and silver acetylide.

9. The heat-developable silver halide color photographic light-sensitive material according to claim 1, wherein the developing agent and the coupler are contained in the same layer provided on the support.

10. A color image-forming method, comprising:
heating the silver halide photographic light-sensitive material of claim 1, at a temperature of 130 to 200° C. for 3 to 30 seconds, thereby forming an image.

11. The method according to claim 10, further comprising:
producing an image signal by reading, by photoelectric means, the image formed on the light-sensitive material, and
obtaining a color image visualized on another display device or output medium, based on the image signal.

12. The method according to claim 11, wherein the reading is carried out by a scanner.
